(19) United States
(12) Patent Application Publication
(10) Pub. No.: US 2022/0235875 A1
(43) Pub. Date: Jul. 28, 2022

(54) VALVE ASSEMBLY

(71) Applicant: Dionex Softron GmbH, Germering (DE)

(72) Inventors: Michael Kolbe, Germering (DE); Thomas Armin Alexander Eichhorn, Munchen (DE); Michael Wohner, Munchen (DE); Adolf Saltzinger, Olching (DE)

(21) Appl. No.: 17/580,880

(22) Filed: Jan. 21, 2022

(30) Foreign Application Priority Data
Jan. 27, 2021 (DE) 10 2021 831.5

(51) Int. Cl. F16K 15/04; F16K 1/42; F16K 25/00; G01N 30/20; G01N 30/36

(52) U.S. Cl. CPC F16K 15/04; F16K 1/42; G01N 2030/328; G01N 30/20; G01N 30/36; F16K 25/005

(57) ABSTRACT

The present invention relates to a valve assembly, comprising a valve chamber, accesses to the valve chamber, the accesses including a first access and a second access, and a movable sealing body assembly comprising at least one sealing portion, wherein at least a portion of the sealing body assembly is magnetic, and wherein at least a portion of the sealing body assembly comprising the at least one sealing portion is located within the valve chamber. Further, the valve assembly comprises at least one sealing surface, wherein each of the at least one sealing surface is configured to complement one of the at least one sealing portion, and wherein each sealing surface comprises an orifice fluidly connected to one of the accesses. The valve assembly further comprises a force unit configured to exert a magnetic force on the magnetic portion of the movable sealing body assembly and is configured to assume at least two configurations, wherein in a first configuration, the first access is sealed, and wherein in a second configuration, the first access is fluidly connected to the second access. Further, the present invention relates to a pump system, as well as a use and manufacturing method of a valve assembly according got the present invention.

### CROSS-REFERENCE TO RELATED APPLICATIONS

This application claims the priority benefit under 35 U.S.C. § 119 to German Patent Application No. 10 2021 831.5, filed on Jan. 27, 2021, which application is hereby incorporated herein by references in its entirety.

The present invention generally relates to the field of valves, more specifically check valves and even more specifically to active check valves.

In particular, the present invention may relate to active check valves configured as inlet and/or outlet valves for pumps, such as high-pressure pumps. Similarly, active check valves according to the present invention may also be used as injection valves, proportioning and dosing valves, or check valves. Therefore, the present invention may particularly relate to the field of liquid chromatography (LC), such as high performance liquid chromatography (HPLC).

HPLC is an analytical method to separate liquid samples into their constituents, wherein the proportions of the individual constituents may be quantified and/or the constituents may be separated for later reuse. In HPLC very precise and uniform flows and pressures of liquids of any kind, that may further be as pulsation-free as possible, may be advantageous. A liquid may usually be provided utilizing a piston pump operating based on the volume displacement principle, which may comprise a plurality of pump units that can be suitably arranged in series or parallel to deliver as pulsation-free a liquid flow as possible up to a maximum defined system pressure. These pumps typically utilize check valves at the inlet and outlet, e.g. in the form of ball valves, which may allow for a flow of the pumped media in one direction (passage direction) and block the flow in opposite direction (blocking direction). Thus, such check valves may typically be comprised by a hydraulic piston pump unit, particularly if it operates according to the volume displacement principle. In some embodiments, check valves may thus be components of a hydraulic piston pump. Very generally, a passive check valve may also be referred to as non-return valve or unidirectional valve.

In HPLC in particular, very small and precise liquid flows may be advantageous for a very wide range of different liquids, e.g. solvents. An active or passive check valve may comprise a very precisely manufactured ball (i.e. a moving sealing body), which may be located in a perfectly adapted ball seat (i.e. a sealing seat). The arrangement of the ball in the ball seat may thus represent a barrier (e.g. a lock) for the flowing liquid, which may exhibit high tightness requirements at different pressure levels. At an equivalent pressure level, however, the unavoidable leakage at the ball seat, which may also be required for passive operation, and the pre-defined flow direction may result in a movement of the ball in the flow direction. Thus, depending on the blocking or passage direction, the flow can increase the tightness or leakage of the barrier and ultimately a blocking or passage behaviour may occur.

For passive check valves, the smallest forces may affect the function, e.g. gravity on the ball and thus the spatial orientation of the check valve, sticking or clamping of the ball in the ball seat at high pressures, leaks due to contaminations in the liquids, etc.

Functional parts, e.g. the ball and the ball seat, may comprise (e.g. consist of) sapphire, ruby or ceramic. These materials may provide the advantage that they are very hard and pressure resistant and may further exhibit a high form and surface quality. This can be advantageous because extremely high pressures may occur locally in the area of the sealing interface (i.e. where ball and ball seat get into contact), which can be many times the fluid pressure. By using these materials a very long lifetime of 10⁸ or more switching cycles can theoretically be assumed, resulting from the high surface hardness and thus low abrasion during operation. However, due to the complex machining of hard materials with very precise geometries and accuracy of fit, manufacture may be quite complex and elaborate.

In addition, active valve circuits, sometimes just referred to as active valves, are also known, which may be fluidically connected to a pump head. Said valve circuits can be actuated electromagnetically at a desired time with an appropriate control and may for example comprise a valve cartridge and a separate, connected actuator. It is known to utilize such active valve circuits as inlet valve of a piston pump, particularly for better controlled pumping of liquids. An example for such a valve is the i² Valve from Waters Corporation, Milford, with a valve cartridge and separate actuator.

Furthermore, there are also spring-assisted check valves, which basically work passively but can show a more reproducible switching behaviour due to the spring force. However, the significantly higher susceptibility to liquids contaminated with particles is known to be a disadvantage.

Generally, passive check valves can comprise a number of disadvantages. For example, passive non-return valves may not be uniformly tight over a complete pressure range, which may impair flow accuracy and thus complex compensation algorithms may be required. Further, passive check valves comprise a preferred installation direction due to gravity, i.e. it may be desirable to arrange the ball as vertically centred as possible above the ball seat. However, this may be disadvantageous for a compact and volume-optimised design.

Furthermore, passive check valves are known to show a high susceptibility to failure for solvents with a strong tendency to polymerisation, e.g. acetonitrile, where often “sticking together” of valves to a point of inoperability can be observed. Also, particle contamination in the liquids/solvents (e.g. samples and eluents) may increase the probability of leaks and malfunctions of the passive check valves.

Passive check valves also show susceptibility to errors due to poorly degassed liquids. Even the smallest air bubbles can form a larger air bubble inside of the valve body. Because of the surface tension a bubble may flow very poorly or not at all through the remaining annular gap between the ball (sealing body) and a “cage” configured to guide the ball. Thus, the ball and the ball seat may not close reliably due to an air bubble being trapped between the sealing body and seat, which may inhibit a sealing connection between the two of for example slow down the process of closing the valve. In particular, behaviour of the valve due to trapped air bubbles may disadvantageously not be reproducible and can thus be particularly problematic. In addition, passive check valves may not close reliably at low differential pressures, which may occur during the transfer phase between a delivery head and a compensating head of a two-stage piston pump.

In order to increase the reliability of passive check valves, it is known to connect two sealing balls and seats in series to provide a double ball valve. In this case it may be sufficient for the correct function, if one of the sealing balls is tightly connected to the respective sealing seat. However, this design variant may have a negative effect regarding size, and complexity of the check valve. Further, the fluid volume comprised by a check valve also has to be considered for the compressible volume of a piston pump, which is functioning according to the principle of volume displacement.

Therefore, the compressible volume may vary depending on the tightness of the two sealing balls and respective sealing seats connected in series and can ultimately alter the compression ratio for each pump stroke.

In contrast, known active check valves may typically be better suited with respect to the problems described above. However, they are generally more complex and may typically be very elaborately designed.

Due to the high switching force, especially at high pressures of the liquids, active check valves may often be large and unwieldy with regard to the external dimensions of the pump heads. Thus, it may often only be feasible to utilize such active check valves as an inlet valve for the pump.

Furthermore, an actuator of known active check valves may typically be located outside the valve chamber and may thus require a mechanical connection into the valve chamber to move the sealing body. Thus, an additional sealing for the mechanical connection between the actuator and the sealing body may disadvantageously be required, which can be quite elaborate as any part going through the sealing will be exerted to mechanical movements.

Basically, a valve cartridge, i.e. an integrated assembly comprising a moving sealing body, static sealing body seat and pressure-resistant jacket, may be mounted separately as a pressure-resistant unit. In order for the valve to function, it is advantageous to seal the moving sealing body (e.g. ball) and the respective guide (e.g. ball retainer, also referred to as ball cage or ball-bearing guide) against each other and against the components in which they are mounted, e.g. housing seal. This seal may typically have to permanently withstand alternating loads up to the maximum pressure of the pump. Although sapphire and ceramics are very pressure-resistant materials, they can only withstand comparatively low tensile loads. If the fluid pressure is applied only inside the sealing seat and ball cage, tensile load may be generated which can cause the material to break when exceeding the material's tensile strength. The pressure of the sealing body on the sealing seat can also lead to a breakage of the seat due to the resulting tensile stress. Such tensile stress may also be referred to as Hertzian contact stress, which generally concerns localized stresses that may develop when two elastic, curved bodies are pressed together under an imposed load.

A number of solutions are known for the problem of limited stability and/or strength of the sealing seat and ball cage. For example, the contact surface between the sealing seat and the ball cage may be designed to leak in a controlled manner to allow pressure equalisation between inside and outside of the ball cage and the sealing seat. When utilizing two single valves as a double ball valve, an additional seal may be provided to ensure that this area is also sealed against the sleeve. Alternatively, the sealing seat may be pressed into a metal ring and thus pre-stressed. However, this may render the manufacture of such a check valve more intricate and complex. Further, it is known to manufacture the ball bearing cage out of stainless steel instead of ceramic, because stainless steel has a higher tensile strength. However, the stability problem of the sealing seat may remain in such realizations.

Furthermore, US 2011/0094954 A1 discloses a spherical seat comprising bevelled outer faces such that a force acting on the valve along the axial direction will generate a force acting on the ball. The inclination of the bevelled outer face may be such that a force acting on the ball counteracts a force exerted on the spherical seat by the ball and essentially compensates it. In other words, it is known to conically ground the sealing seat and suitably preload it by corresponding counterparts. However, this typically requires an increased number of components with complex contours, especially for a double ball valve, rendering the check valve more complex.

If hard materials are used for the moving sealing body and sealing seat, well-known active check valves according to the state of the art may typically also be susceptible to particles. Overall, check valves for HPLC piston pumps according to the known designs may be complex and thus also intensive in production.

In light of the above, it is an object to overcome or at least alleviate the shortcomings and disadvantages of the prior art. That is, it may be an object of the present invention to provide an improved active check valve which may provide an improved tightness and/or reliability.

These objects are met by the present invention.

In a first embodiment, the present invention relates to a valve assembly. The valve assembly comprises a valve chamber and accesses to the valve chamber, wherein the accesses include a first access and a second access, as well as a movable sealing body assembly comprising at least one sealing portion, wherein at least a portion of the sealing body assembly comprising the at least one sealing portion is located within the valve chamber and wherein at least a portion of the sealing body assembly is magnetic. The valve assembly further comprises a force unit configured to exert a magnetic force on the magnetic portion of the movable sealing body assembly and at least one sealing surface, wherein each of the at least one sealing surface is configured to complement one of the at least one sealing portion and wherein each sealing surface comprises an orifice fluidly connected to one of the accesses. Furthermore, the valve assembly is configured to assume at least two configurations, wherein in a first configuration, the first access is sealed, and wherein in a second configuration, the first access is fluidly connected to the second access.

The at least a portion of the sealing body assembly that is magnetic may also be referred to as “magnetic portion”. However, it should be understood that in some embodiments, this magnetic portion may also be the complete sealing body assembly.

Generally, such a valve assembly may for example be used as an injection valve in a sampler of a chromatography application, as an inlet and/or outlet valve of a pump, as metering and/or proportioning valve, as flush valve, as check valve or for switching chromatography columns, e.g. HPLC columns.

The force unit may further be configured to exert the magnetic force on the magnetic portion of the movable sealing body without any physical contact between the force unit and the sealing body assembly. That is, the force transmission may be contactless.

The sealing surface and the sealing portion configured to complement said sealing surface may be configured to form a leak-tight sealing interface when pressed together, which seals the orifice comprised by the sealing surface.

That is, by pressing the sealing portion onto the complementary sealing surface, the fluid connection to the access fluidly connected to the orifice comprised by the sealing surface is sealed, i.e. blocked in a leak-tight manner. In other words, the sealing surface and the sealing portion may provide a sealing interface when in contact with each other, which may be configured such that substantially no fluid may leak through. The term “substantially” serves to include a residual leak rate, which may for example not be avoided due to technical limitations. Generally, the phrase “leak-tight” may denote a sealed connection, e.g. the leak-tight sealing interface, that comprises a residual leak rate of less or equal to 100 nl/min, preferably less or equal to 50 nl/min, more preferably less or equal to 5 nl/min.

It will be understood that the sealing surface may for example be a ball seat or more generally a sealing seat, configured to receive the respective sealing portion. Generally, the sealing surface may be any type and shape of surface that, in combination with the respective sealing portion of the sealing body assembly, may provide the sealing interface. That is, the sealing surface may generally also denote a quasi-two-dimensional surface—it may for example have the shape of a ring.

The sealing portion may generally be the portion of the sealing body assembly that complements the sealing surface. That is, the portion of the sealing body assembly that gets into contact with the sealing surface to form the leak-tight sealing interface.

Generally, the sealing interface may denote the contact surface of the sealing portion and the sealing surface. In other words, the sealing interface may be the projected area of the sealing portion and the sealing surface. For a typical (passive) check valve, the ball may constitute the sealing portion and the sealing seat may constitute the sealing surface. Thus, the sealing interface would be the contact area between the ball and the ball seat.

The leak-tight sealing interface may comprise a residual leak rate of up to 100 nl/min, preferably up to 50 nl/min more preferably up to 5 nl/min.

It may be preferred to keep the projected surface between the sealing portion and the sealing surface, i.e. the sealing interface small. Further, the orifice comprised by each sealing surface comprises an inner diameter of less than 5 mm, preferably less than 1 mm, more preferably less than 0.5 mm.

In some embodiments, a hardness of the at least one sealing portion may be different to a hardness of the at least one sealing surface. In particular, the at least one sealing portion may comprise a greater hardness than the respective sealing surface. Further, the sealing surface and the sealing portion configured to complement said sealing surface may be calibrated with respect to each other to form an accurately fitting sealing contour. That is, the sealing surface and the respective sealing portion may be shaped with respect to each other to provide complementary geometries that allow to form the leak-tight sealing interface when pressed together. For example, the sealing surface and the respective sealing portion may be pressed together by applying a mechanical or hydraulic pressure, and consequently, due to the differing hardness, the harder portion may deform the softer portion to provide an accurately fitting sealing contour, and thus a leak-tight sealing interface. Thus, the calibration may comprise pressing together the sealing surface and the corresponding sealing portion by means of a pressure exceeding the smaller of the yield strength of the sealing portion and the yield strength of the sealing surface. That is, for example if the sealing surface is made of PEEK, the pressure may be around 100 MPa corresponding to 100 N/mm² or respectively 1000 bar to guarantee plastic deformation to a sufficient degree. In some embodiments, the calibration may comprise pressing together the sealing surface and the corresponding sealing portion by means of a pressure corresponding to a tension of at least 10 N/mm², preferably at least 50 N/mm², more preferably at least 100 N/mm².

The valve assembly may comprise at least one sealing surface for each of the at least one sealing portion.

The valve chamber may at least partially be defined by a chamber body. At least a portion of the chamber body may be substantially non-ferromagnetic. That is, it may not provide substantial magnetic shielding, such that a magnetic field may reach through the at least a portion of the chamber body. For example, the ends of a cylindrical valve chamber may be made of ferromagnetic material, which may advantageously aid with providing a string and homogeneous field in the central portion of the cylindrical valve chamber. The term substantially serves to allow for small ferromagnetic contributions that do not suffice to provide magnetic shielding properties. It will be understood that the at least a portion of the chamber body may also include the entire chamber body.

At least a portion of the chamber body may be made from titanium, MP35N, ceramic, polyketone (PK), polyether ether ketone (PEEK), austenitic stainless steel, or a combination thereof. In some embodiment the entire chamber body may be made from one of the former mentioned materials or a combination thereof. For example, the titanium may be titanium Grade 5, such as 3.7164 or 3.7165, and/or the austenitic stainless steel may be one of 1.4404, 1.4435 or 1.4571.

The chamber body may be configured to withstand a pressure of 50 bar, preferably 100 bar, more preferably 400 bar, further preferably 800 bar. When it is stated that a part or portion, e.g. the chamber body, is configured to withstand a pressure of, e.g., 400 bar, it should be understood that this merely means that the part or portion is in particular configured to withstand at least such a pressure. That is, it can be operated at such a pressure. However, it should be understood that this does not preclude the part or portion to also be configured to withstand other pressures. In other words, the part or portion, e.g. chamber body, being configured to withstand, e.g., 400 bar, merely defines a minimum requirement, but does not exclude that the part or portion can also be operated at other pressures. Corresponding considerations also apply to the other components and pressures mentioned in this document.

In some embodiments, at least one access to the valve chamber may be provided by a channel through the chamber body. Additionally or alternatively, the chamber body may comprise at least one opening and wherein each of the at least one opening is sealed with a respective chamber seal. Further, at least one access to the valve chamber may be provided by a channel through a chamber seal. The chamber seal may be configured to withstand a static pressure of 50 bar, preferably 100 bar, more preferably 400 bar, further preferably 800 bar. At least a portion of the chamber seal may be made of polyether ether ketone (PEEK), polytetrafluoroethylene (PTFE), and/or FFKM. In general, any seal or sealing element comprised by the valve assembly may be made of one of these materials.

The valve chamber may comprise a valve chamber volume. Further, the valve chamber volume may be smaller than 500 μl, preferably smaller than 100 μl, more preferably smaller than 50 μl. In some embodiments, the valve chamber may comprise a dead volume of less than 50 μl, preferably less than 30 μl, more preferably less than 5 μl, for example 0.1 μl to 30 μl.

“Dead volume” may denote the volume within the valve chamber, which comprises not flushed fluid during the operation. That is, dead volume may refer to volume of the valve chamber that is not directly flushed in any position/configuration of the valve. Thus, the dead volume may not be flushed directly and/or completely, which may lead to accumulation of residues of earlier sample and thus contamination of subsequent samples.

In some embodiments, the sealing body assembly may be entirely located within the valve chamber. That is, the sealing body assembly is entirely located within the valve chamber volume.

Further, the portion of the sealing body assembly that is located within the valve chamber may comprise an extension in one direction, e.g., a diameter that is smaller than 10 mm, preferably smaller than 5 mm, more preferably smaller than 3 mm.

The valve chamber may further comprise a central axis running centrally through two opposing sides of the valve chamber. That is, the central axis may run through each centre of two opposing sides of the valve chamber. The central axis may run in a direction of maximum extent of the valve chamber.

The at least a portion of the sealing body assembly located within the valve chamber may be movable within the valve chamber along the central axis.

The magnetic portion of the sealing body assembly may comprise a magnetic material, wherein the magnetic material is one of a ferrite or a ferromagnetic material. The magnetic material may generally be a hard- or soft-magnetic material. In some embodiments, the magnetic material may be a hard-magnetic material. That is a material that may typically be used for permanent magnets. A hard-magnetic material may comprise a high intrinsic coercivity (H_{cJ}), e.g. an intrinsic coercivity greater than 1 kA/m, wherein the intrinsic coercivity corresponds to the field strength necessary for the magnetic polarization to disappear. That is, it may be a measure for a magnet's resistance to demagnetization. The magnetic material may be one of a hard ferrite, Nd₂Fe₁₄B, SmCo, such as SmCo₅ or Sm₂Co₁₇, or an iron, cobalt and/or nickel alloy, such as Alnico.

The magnetic portion may be surrounded by a non-magnetic portion of the sealing body assembly. That is, the magnetic portion may be a magnetic core within the sealing body assembly. Alternatively, the entire sealing body assembly may be magnetic.

At least an exterior portion of the sealing body assembly may be corrosion-resistant. In some embodiments, the sealing body assembly may be coated with a corrosion-resistant coating. The corrosion-resistant coating may for example comprise one of gold, a diamond-like carbon (DLC) or parylene. Further, the sealing body assembly may be configured to withstand an ambient pressure of 50 bar, preferably 100 bar, more preferably 400 bar, further more preferably 800 bar.

The at least one sealing portion may be shaped as a ball, a tip, a cone, a hyperboloid or a conical frustum. The at least one sealing portion may be formed separately from the remaining sealing body assembly. Alternatively, the sealing portion may be integrally formed with at least one further portion of the sealing body assembly.

In some embodiments, the valve assembly may comprise a third access to the valve chamber. Further, two of the accesses to the valve chamber may be located on opposite sides of the valve chamber. Yet further, the two accesses may lie on the central axis of the valve chamber.

The central axis of the valve chamber may also run centrally through two opposing sides of the magnetic portion.

The force, the force unit is configured to exert on the magnetic portion, may be substantially parallel to the central axis of the valve chamber. Additionally or alternatively, the force unit may be configured to press the sealing portion against the complementary sealing surface by exerting the force on the magnetic portion.

The force exerted by the force unit onto the magnetic portion may be greater than 0.05 N, preferably greater than 0.5 N, more preferably greater than 1.5 N. In some embodiments, the force unit may be configured to move the sealing body assembly by exerting the force on the magnetic portion. Further, the force unit may be configured to actively change the configuration assumed by the valve assembly by exerting the force on the magnetic portion.

The force unit may be configured to move the sealing body assembly and/or to actively change the configuration assumed by the valve assembly at least for any differential pressure between any of the accesses to the valve chamber that does not exceed a differential pressure threshold, wherein the differential pressure threshold is at least 20 bar, preferably at least 50 bar, more preferably at least 100 bar. For example, the differential pressure threshold may be 120 bar. In other words, at least any pressure difference up to the differential pressure threshold may be overcome by the force unit. It will be understood, that this does not exclude the force unit overcoming a differential pressure exceeding the differential pressure threshold.

In some embodiments, the force unit may comprise at least one permanent magnet. The at least one permanent magnet may be configured to provide a magnetic flux density (also referred to as magnetic induction or magnetic field) of at least 250 mT, preferably 500 mT, more preferably 700 mT. In other words, the at least one permanent magnet may comprise a remanence (also referred to as remanent magnetization or residual magnetism) of at least 250 mT, preferably 500 mT, more preferably 700 mT. The at least one permanent magnet may comprise at least one of Nd₂Fe₁₄B, SmCo, such as SmCo₅ or Sm₂Co₁₇, or an iron, cobalt and/or nickel alloy such as Alnico. That is, the at least one permanent magnet may for example be made of one of the preceding materials.

The at least one magnet may be an annular magnet comprising an axial magnetization direction along a rotational symmetry axis. That is, in the centre of the annular magnet the magnetic field may be oriented along the axis around which the annular magnet is rotationally symmetric, i.e. the rotational symmetry axis. In other words, the magnetization direction of the annular magnet is directed perpendicular to a radial direction defined by the ring geometry. Further, the annular magnet may be fitted around at least a portion of the valve chamber. The rotational symmetry axis of the annular magnet may coincide with the central axis of the valve chamber.

In some embodiments, the at least one permanent magnet may be a bar magnet. It will be understood that the term “bar magnet” is a general term that may not be limited to rectangular-shaped bar magnets, but for example also refer to cylindrically-shaped bar magnets (also known as rod magnets) or otherwise shaped bar magnets, e.g. bar magnets with an elliptical cross section. Further, the force unit may comprise two bar magnets. The force unit may comprise an actuator configured to provide a rotational or linear motion. The at least one permanent magnet may be connected to the actuator either directly or by means of a coupling unit. The actuator may be configured to provide a linear or rotational displacement to the at least one permanent magnet connected thereto. That is, the actuator may be configured to linearly or rotationally displace the at least one permanent magnet, which may be connected to the actuator either directly or indirectly, i.e. by means of a coupling unit.

In embodiments comprising an annular magnet, the actuator may be configured to linearly displace the annular magnet in the direction of the rotational symmetry axis of the annular magnet. That is, in embodiments, wherein the at least one permanent magnet of the force unit is an annular magnet, said annular magnet may be linearly displaced by the actuator it is connected to. It will be understood that an annular magnet may for example be a ring magnet.

In embodiments wherein the force unit comprises two bar magnets, the bar magnets may be arranged next to each other in the direction of the linear or rotational displacement provided by the actuator. Further, the magnetization direction of the bar magnets may be perpendicular to the direction of the linear or rotational displacement and the magnetization direction of the bar magnets may be opposite to each other. Further, the actuator may be configured to linearly or rotationally displace the bar magnets in a plane perpendicular to the central axis of the valve chamber, wherein the magnetization direction of the bar magnets is preferably parallel to the central axis of the valve chamber.

The force unit may comprise at least one solenoid, which may also be referred to as electromagnetic solenoid. A solenoid may typically be an electromagnetic device comprising a conductive wire that is tightly wound into a helix, which may act as an electromagnet when passing a current through the wire. The direction of the current passing through the wire may determine the direction of the magnetic field. Each of the at least one solenoid may be fitted around at least a portion of the chamber body, respectively. Further, a rotational symmetry axis of the at least one solenoid may coincide with the central axis of the valve chamber. The valve assembly may be configured to switch a magnetization direction of the at least one solenoid.

In some embodiments, the at least one solenoid may be two solenoids. Further, both solenoids may provide the same magnetization direction. Alternatively, the two solenoids may be configured to provide alternate magnetization directions, wherein only one solenoid may generate a magnetic field at a time.

The at least one solenoid may be configured to provide a magnetic flux density of at least 250 mT, preferably at least 500 mT, more preferably at least 700 mT.

In some embodiments, at least one access to the valve chamber may comprise a fitting for a connection to a capillary. That is, at least one access of the valve chamber may be configured to be indirectly connected to a capillary, wherein the term “indirectly” denotes use of a respective fitting, e.g. an adapter. Thus, it may for example be possible to disconnect the capillary, e.g. by means of a threaded fitting, a bayonet fitting or other suitable fittings. In other words, the connection may not be permanent.

Additionally or alternatively, at least one access to the valve chamber may be directly connected to a capillary. Here, the term “directly” denotes that no further component, e.g. fitting, is involved. For example, the capillary may directly be fused or glued to the respective access, or formed in one part with the respective portion of the valve, e.g. the chamber body. Thus, the connection may be permanent.

The valve assembly may further comprise a cavity. The cavity may comprise a central cavity axis which is aligned with the central axis of the valve chamber. Further, the cavity may be fluidly connected to the valve chamber through one of the accesses to the valve chamber. Additionally or alternatively, the cavity may be fluidly connected to a fitting configured to connect a capillary. Again, this may allow to fluidly connect a capillary with the cavity by means of a suitable fitting, e.g. the fitting may be a socket for a respective plug fixedly attached to the capillary. This may for example allow for the capillary to be disconnected whenever suitable.

Additionally, or alternatively, the cavity may be directly fluidly connected to a capillary. That is, the fluid connection between the capillary and the cavity may not involve a fitting. Such a direct fluid connection may for example be established by means of fusing or gluing the capillary in fluid connection with the cavity, e.g. directly to the cavity or a fluid access to the cavity. Again, the capillary may for example also be formed in one part with a respective portion of the valve.

In some embodiments a portion of the sealing body assembly may be located within the cavity. The portion of the sealing body assembly located within the cavity may comprise the magnetic portion of the sealing body assembly. Further, the force unit may be configured to selectively align one of the two bar magnets opposite to the magnetic portion in a plane perpendicular to the central axis. For example, the force unit may displace the two bar magnets utilizing the actuator, such that one of the bars is selectively aligned with the magnetic portion located in the cavity. The actuator may displace the two bar magnets in a plane perpendicular to the central axis. For example, the bar magnet and the magnetic portion may both lie on the central axis and/or the central cavity axis when being aligned opposite to each other.

The valve assembly may be configured to operate at a pressure of up to 50 bar, preferably at a pressure of up to 100 bar, more preferably at a pressure of up to 400 bar, further preferably at a pressure of up to 800 bar. It will be understood that this defines a minimum requirement and that the valve assembly may always be configured for even higher pressures, e.g. a valve assembly configured to operate at a pressure of up to 800 bar may in some cases also operate at pressures up to for example 1000 bar, or even 1,500 bar.

In some embodiments the valve assembly may comprise a cover configured to encase at least a portion of the valve assembly. The cover may be configured to protect the encased portions of the valve assembly from environmental influences. Further, the cover may be configured as a shield for magnetic fields. The cover may be made of a ferrite or a ferromagnetic material. That is, the cover may generally be made of a hard or soft magnetic material. In some embodiments, the cover may preferably be made of a soft-magnetic material. The cover may encase at least a portion of the force unit and a portion of the valve chamber.

The movable sealing body assembly may not be firmly attached to any other portion of the valve assembly. That is, the movable sealing body assembly may float within the valve assembly, e.g. within the valve chamber and/or the cavity. In other words, the movable sealing body assembly may get into contact with other portions of the valve assembly, which may typically encase the movable sealing body assembly, however it may not be firmly attached thereto, e.g. by means of a spring.

In some embodiments, at least a portion of the valve assembly may be made from titanium, MP35N, ceramic, polyketone (PK), polyether ether ketone (PEEK), and/or austenitic stainless steel. Further, the titanium may be titanium Grade 5, such as 3.7164 or 3.7165, and/or the austenitic stainless steel may be one of 1.4404, 1.4435 or 1.4571.

The at least one sealing portion of the valve assembly may be made of at least one of polyether ether ketone (PEEK), sapphire, ruby, aluminium oxide, zirconium dioxide, or silicon dioxide. Similarly, the at least one sealing surface may be made of at least one of polyether ether ketone (PEEK), sapphire, ruby, aluminium oxide, zirconium dioxide, or silicon dioxide.

In another embodiment, the present invention relates to a pump system configured to provide a low of fluid. The pump system comprises at least one pump unit, an inlet valve configured to control a fluid flow at an inlet of at least one of the at least one pump unit and an outlet valve configured to control a fluid flow at an outlet of at least one of the at least one pump unit. Further, at least one of the inlet valve and the outlet valve is a valve assembly as described above.

The at least one pump unit may be a positive displacement pump unit. Further, the at least one pump unit may be a piston pump unit. The pump system may be configured to at least provide a flow of fluid with a flow rate in the range of 0.01 mL/min to 1 mL/min, preferably 0.005 mL/min to 5 mL/min, more preferably 0.001 mL/min to 10 mL/min. Additionally or alternatively, the pump system may be configured to operate at an output pressure of at least 50 bar, preferably at least 100 bar, more preferably at least 400 bar, even more preferably at least 800 bar.

The pump system may comprise a plurality of pump units. Further, at least a subset of the plurality of pump units may be fluidly connected in series. Additionally or alternatively, at least a subset of the plurality of pump units may be fluidly connected in parallel.

The pump system may be configured for reversing the flow through the pump system to purge the system. That is, the pump system may be configured to backflush the system, which may advantageously aid with cleaning the system.

In another embodiment, the present invention relates to a use of the valve assembly as described above for controlling the flow of a fluid and/or a use of the pump system as described above for providing a fluid flow.

The use may be in at least one of chromatography, liquid chromatography, high performance liquid chromatography, ultra-high performance liquid chromatography. Furthermore, the use may be at a pressure exceeding 50 bar, preferably exceeding 100 bar, more preferably exceeding 400 bar, even more preferably exceeding 800 bar.

The use of a valve assembly as specified above and comprising a third access may comprise actively switching the valve configuration to provide at the second access of the valve assembly a mixture of a fluid supplied at the first access and a fluid supplied at the third access. That is, a valve assembly according to the present invention and comprising 3 accesses may be used as a proportioning valve, also referred to as mixing valve, wherein two fluids supplied to the valve chamber through closable accesses (i.e. first and third access) may be mixed by alternatively switching between opening and closing the respective accesses. Thus, a mixture of the respective fluids, e.g. solvents, may be supplied at the second access.

In a further embodiment, the present invention relates to a manufacturing method for manufacturing a valve assembly as described above. The manufacturing may comprise calibrating the at least one sealing portion and/or the complementary sealing surface to provide an accurately fitting sealing contour. The step of calibrating may comprise forming the sealing surface with a pre-press tool. That is, the sealing surface may be calibrated by pressing the shape of the at least one sealing portion into the complementary sealing surface utilizing a pre-press tool. In other words, the sealing portion, or a portion resembling the shape of the sealing portion may be pressed into the respective sealing surface to thereby form, i.e. calibrate, the sealing surface such that it provides an accurately fitting sealing contour in combination with the respective sealing portion.

The at least one sealing portion and the complementary sealing surface may comprise different degrees of hardness, and wherein the step of calibrating may comprise applying a hydraulic pressure configured to press the sealing portion and the sealing surface together while the valve assembly is assembled. In other words, the sealing portion may be pressed against or into the sealing surface by applying a hydraulic pressure while the valve is in an assembled state. The applied hydraulic pressure may exceed the smaller of the yield strength of the sealing portion and the yield strength of the sealing surface. That is, for example if the sealing surface is made of PEEK, the pressure would be required to be around 100 MPa corresponding to 100 N/mm² or respectively 1000 bar to guarantee plastic deformation to a sufficient degree.

Generally, during calibration the contact pressure of a surface pressure may be on the order of the yield point but smaller than the strength of the material so as to deform but not damage the respective portion. In some embodiments, the applied hydraulic pressure may correspond to a tension of at least 10 N/mm², preferably at least 50 N/mm², more preferably at least 100 N/mm².

The valve assembly described above may be manufactured using the above manufacturing method.

That is, the present invention may provide an active check valve comprising a very small, compact design, which may be significantly less complex than previous versions and may also provide a better robustness compared to check valves known in the state of the art. In particular, it may provide a high operating reliability, e.g. for operating with particle-contaminated liquids and/or liquids comprising air bubbles. Additionally or alternatively, the valve assembly may have an easy and non-complex interchangeability in the field. That is, it may be possible that the valve is replaced by a customer without any special experience. That is, it may be easier to use than previously known active check valves.

In particular, actively actuating the movable sealing body assembly may advantageously provide additional functionalities for such check valves. First of all, it may allow for a significantly improved tightness over the entire specified pressure range, e.g. working pressure and system pressure. Further, the volume within the valve chamber, that is actually flushed with liquid, i.e. the chamber volume that is not filled with any portion of the sealing body assembly, may be very small. In other words, the dead volume may be minimized, particularly in comparison to utilizing two sealing bodies and sealing seats, e.g. two check valves in series. Furthermore, an active check valve according to the present invention may enable (active) diagnostics and regeneration procedures. Diagnostics procedures may for example comprise monitoring electrical signals corresponding to movements of the magnets and/or other parts of the force unit, which may allow for extracting information relating to their current condition and development thereof. On the other hand, regeneration procedures may for example comprise self-cleaning of the valve, e.g. by means of a high-frequency circuit (e.g. up to 100 Hz), which may release particles and/or air bubbles by inducing high-frequency movements of the sealing assembly. Furthermore, it may allow for backwashing of a piston pump up to a limited pressure (backwashing pressure), e.g. approximately 50 bar, provided the valve according to the present invention is utilized both as inlet and as outlet valve of the piston pump. This may provide a big advantage for the injection unit of a chromatography system when washing the injection needle via a metering device.

Below, reference will be made to valve assembly embodiments. These embodiments are abbreviated by the letter “A” followed by a number. Whenever reference is herein made to “assembly embodiments”, these embodiments are meant.

A1. A valve assembly, comprising

a valve chamber;

accesses to the valve chamber, the accesses including a first access and a second access;

a movable sealing body assembly comprising at least one sealing portion,

wherein at least a portion of the sealing body assembly is magnetic, and
wherein at least a portion of the sealing body assembly comprising the at least one sealing portion is located within the valve chamber;
at least one sealing surface,
wherein each of the at least one sealing surface is configured to complement one of the at least one sealing portion, and
wherein each sealing surface comprises an orifice fluidly connected to one of the accesses; and
a force unit configured to exert a magnetic force on the magnetic portion of the movable sealing body assembly,
wherein the valve assembly is configured to assume at least two configurations,
wherein in a first configuration, the first access is sealed, and
wherein in a second configuration, the first access is fluidly connected to the second access.

A2. The valve assembly according to the preceding assembly embodiment, wherein the force unit is configured to exert the magnetic force on the magnetic portion of the movable sealing body without any physical contact between the force unit and the sealing body assembly.

A3. The valve assembly according to any of the 2 preceding assembly embodiments, wherein the sealing surface and the sealing portion configured to complement said sealing surface are configured to form a leak-tight sealing interface when pressed together, which seals the orifice comprised by the sealing surface.

A4. The valve assembly according to the preceding assembly embodiment, wherein the leak-tight sealing interface comprises a residual leak rate of up to 100 nl/min, preferably up to 50 nl/min more preferably up to 5 nl/min.

A5. The valve assembly according to any of the preceding assembly embodiments, wherein the orifice comprised by each sealing surface comprises an inner diameter of less than 5 mm, preferably less than 1 mm, more preferably less than 0.5 mm.

A6. The valve assembly according to any of the preceding assembly embodiments, wherein a hardness of the at least one sealing portion is different to a hardness of the at least one sealing surface.

A7. The valve assembly according to the preceding assembly embodiment, wherein the at least one sealing portion comprises a greater hardness than the respective sealing surface.

A8. The valve assembly according to any of the 2 preceding assembly embodiments, wherein the sealing surface and the sealing portion configured to complement said sealing surface are calibrated with respect to each other to form an accurately fitting sealing contour.

A9. The valve assembly according to the preceding assembly embodiment, wherein the calibration comprises pressing together the sealing surface and the corresponding sealing portion by means of a pressure exceeding the smaller of the yield strength of the sealing portion and the yield strength of the sealing surface.

A10. The valve assembly according to any of the 2 preceding assembly embodiments, wherein the calibration comprises pressing together the sealing surface and the corresponding sealing portion by means of a pressure corresponding to a tension of at least 10 N/mm², preferably at least 50 N/mm², more preferably at least 100 N/mm².

A11. The valve assembly according to any of the preceding assembly embodiments, wherein the valve assembly comprises at least one sealing surface for each of the at least one sealing portion.

A12. The valve assembly according to any of the preceding assembly embodiments, wherein the valve chamber is at least partially defined by a chamber body.

A13. The valve assembly according to the preceding assembly embodiment, wherein at least a portion of the chamber body is substantially non-ferromagnetic.

A14. The valve assembly according to any of the 2 the preceding assembly embodiments, wherein the chamber body is substantially non-ferromagnetic.

A15. The valve assembly according to any of the 3 preceding assembly embodiments, wherein at least a portion of the chamber body is made from titanium, MP35N, ceramic, polyketone (PK), polyether ether ketone (PEEK), austenitic stainless steel or a combination thereof.

A16. The valve assembly according to any of the 4 preceding assembly embodiments, wherein the chamber body is made from titanium, MP35N, ceramic, polyketone (PK), polyether ether ketone (PEEK), austenitic stainless steel or a combination thereof.

A17. The valve assembly according to any of the 2 preceding assembly embodiments, wherein the titanium is titanium Grade 5, such as 3.7164 or 3.7165.

A18. The valve assembly according to any of the 3 preceding assembly embodiments, wherein the austenitic stainless steel is one of 1.4404, 1.4435 or 1.4571.

A19. The valve assembly according to any of the 7 preceding assembly embodiments, wherein the chamber body is configured to withstand a pressure of 50 bar, preferably 100 bar, more preferably 400 bar, further preferably 800 bar.

A20. The valve assembly according to any of the 8 preceding assembly embodiments, wherein at least one access to the valve chamber is provided by a channel through the chamber body.

A21. The valve assembly according to any of the 9 preceding assembly embodiments, wherein the chamber body comprises at least one opening and wherein each of the at least one opening is sealed with a respective chamber seal.

A22. The valve assembly according to the preceding assembly embodiments, wherein at least one access to the valve chamber is provided by a channel through a chamber seal.

A23. The valve assembly according to any of the 2 preceding assembly embodiments, wherein the chamber seal is configured to withstand a static pressure of 50 bar, preferably 100 bar, more preferably 400 bar, further preferably 800 bar.

A24. The valve assembly according to any of the 3 preceding assembly embodiments, wherein at least a portion of the chamber seal is made of polyether ether ketone (PEEK), polytetrafluoroethylene (PTFE), and/or FFKM.

A25. The valve assembly according to any of the preceding assembly embodiments, wherein the valve chamber comprises a valve chamber volume.

A26. The valve assembly according to the preceding assembly embodiment, wherein the valve chamber volume is smaller than 500 μl, preferably smaller than 100 μl, more preferably smaller than 50 μl.

A27. The valve assembly according to any of the preceding assembly embodiments, wherein the valve chamber comprises a dead volume of less than 50 μl, preferably less than 30 μl, more preferably less than 5 μl.

A28. The valve assembly according to any of the preceding assembly embodiments, wherein the sealing body assembly is entirely located within the valve chamber.

That is, the sealing body assembly is entirely located within the valve chamber volume.

A29. The valve assembly according to any of the preceding assembly embodiments, wherein the portion of the sealing body assembly that is located within the valve chamber comprises an extension in one direction, e.g., a diameter, that is smaller than 10 mm, preferably smaller than 5 mm, more preferably smaller than 3 mm.

A30. The valve assembly according to any of the preceding assembly embodiments, wherein the valve chamber comprises a central axis running centrally through two opposing sides of the valve chamber.

That is, the central axis may run through each centre of two opposing sides of the valve chamber.

A31. The valve assembly according to the preceding assembly embodiment, wherein the central axis runs in a direction of maximum extent of the valve chamber.

A32. The valve assembly according to any of the 2 preceding assembly embodiments, wherein the at least a portion of the sealing body assembly located within the valve chamber is movable within the valve chamber along the central axis.

A33. The valve assembly according to any of the preceding assembly embodiments, wherein the magnetic portion of the sealing body assembly comprises a magnetic material, wherein the magnetic material is one of ferrite or a ferromagnetic material.

A34. The valve assembly according to the preceding assembly embodiment, wherein the magnetic material is a hard-magnetic material.

A35. The valve assembly according to any of the 2 preceding assembly embodiments, wherein the magnetic material is one of, a hard ferrite, Nd₂Fe₁₄B, SmCo, such as SmCo₅ or Sm₂Co₁₇, or an iron, cobalt and/or nickel alloy such as Alnico.

A36. The valve assembly according to any of the preceding assembly embodiments, wherein the magnetic portion is surrounded by a non-magnetic portion of the sealing body assembly.

A37. The valve assembly according to any of the preceding assembly embodiments, excluding the features of embodiment A36, wherein the entire sealing body assembly is magnetic.

A38. The valve assembly according to the any of the preceding assembly embodiments, wherein at least an exterior portion of the sealing body assembly is corrosion-resistant.

A39. The valve assembly according to the any of the preceding assembly embodiments, wherein the sealing body assembly is coated with a corrosion-resistant coating.

A40. The valve assembly according to the preceding assembly embodiment, wherein the corrosion-resistant coating comprises one of gold, a diamond-like carbon (DLC), polyketone (PK), polyether ether ketone (PEEK) or parylene.

A41. The valve assembly according to any of the preceding assembly embodiments, wherein the sealing body assembly is configured to withstand an ambient pressure of 50 bar, preferably 100 bar, more preferably 400 bar, further more preferably 800 bar.

A42. The valve assembly according to any of the preceding assembly embodiments, wherein the at least one sealing portion is shaped as a ball, a tip, a cone, a hyperboloid or a conical frustum.

A43. The valve assembly according to any of the preceding assembly embodiments, wherein the at least one sealing portion is formed separately from the remaining sealing body assembly.

A44. The valve assembly according to any of the preceding assembly embodiments excluding the features of A43, wherein the sealing portion is integrally formed with at least one further portion of the sealing body assembly.

A45. The valve assembly according to any of the preceding assembly embodiments, wherein the valve assembly comprises a third access to the valve chamber.

A46. The valve assembly according to the preceding assembly embodiment, wherein two of the accesses to the valve chamber are located on opposite sides of the valve chamber.

A47. The valve assembly according to the preceding assembly embodiment and with the features of A30, wherein the two accesses lie on the central axis of the valve chamber.

A48. The valve assembly according to any of the preceding assembly embodiments with the features of A30, wherein the central axis of the valve chamber also runs centrally through two opposing sides of the magnetic portion.

A49. The valve assembly according to any of the preceding assembly embodiments with the features of A30, wherein the force, the force unit is configured to exert on the magnetic portion, is substantially parallel to the central axis of the valve chamber.

A50. The valve assembly according to any of the preceding assembly embodiments, wherein the force unit is configured to press the sealing portion against the complementary sealing surface by exerting the force on the magnetic portion.

A51. The valve assembly according to the any of the preceding assembly embodiments, wherein the force exerted by the force unit onto the magnetic portion is greater than 0.05 N, preferably greater than 0.5 N, more preferably greater than 1.5 N.

A52. The valve assembly according to any of the preceding assembly embodiments, wherein the force unit is configured to move the sealing body assembly by exerting the force on the magnetic portion.

A53. The valve assembly according to any of the preceding assembly embodiments, wherein the force unit is configured to actively change the configuration assumed by the valve assembly by exerting the force on the magnetic portion.

A54. The valve assembly according to any of the 2 preceding assembly embodiments, wherein the force unit is configured to move the sealing body assembly and/or to actively change the configuration assumed by the valve assembly at least for any differential pressure between any of the accesses to the valve chamber that does not exceed a differential pressure threshold, wherein the differential pressure threshold is at least 20 bar, preferably at least 50 bar, more preferably at least 100 bar.

A55. The valve assembly according to any of the preceding assembly embodiments, wherein the force unit comprises at least one permanent magnet.

A56. The valve assembly according to the preceding assembly embodiment, wherein the at least one permanent magnet is configured to provide a magnetic flux density of at least 250 mT, preferably 500 mT, more preferably 700 mT.

A57. The valve assembly according to any of the 2 preceding assembly embodiments, wherein the at least one permanent magnet comprises at least one of Nd₂Fe₁₄B, SmCo, such as SmCo₅ or Sm₂Co₁₇, or an iron, cobalt and/or nickel alloy such as Alnico.

A58. The valve assembly according to any of the 3 preceding assembly embodiments, wherein the at least one magnet is an annular magnet comprising an axial magnetization direction along a rotational symmetry axis.

A59. The valve assembly according to the preceding assembly embodiment and with the features of assembly embodiment A12, wherein the annular magnet is fitted around at least a portion of the chamber body.

A60. The valve assembly according to the preceding assembly embodiment with the features of A30, wherein the rotational symmetry axis of the annular magnet coincides with the central axis of the valve chamber.

A61. The valve assembly according to any of the preceding assembly embodiments and with the features of embodiment A55, wherein the at least one permanent magnet is a bar magnet.

A62. The valve assembly according to the preceding embodiment, wherein the force unit comprises two bar magnets.

A63. The valve assembly according to any of the preceding assembly embodiments, wherein the force unit comprises an actuator configured to provide a rotational or linear motion.

A64. The valve assembly according to the preceding assembly embodiment and including the features of A55, wherein the at least one permanent magnet is connected to the actuator either directly or by means of a coupling unit.

A65. The valve assembly according to any of the 2 preceding assembly embodiments, wherein the actuator is configured to provide a linear or rotational displacement to the at least one permanent magnet connected thereto.

A66. The valve assembly according to the preceding assembly embodiment and with the features of A58, wherein the actuator is configured to linearly displace the annular magnet in the direction of the rotational symmetry axis of the annular magnet.

A67. The valve assembly according to the penultimate assembly embodiment and with the features of A62, wherein the bar magnets are arranged next to each other in the direction of the linear or rotational displacement provided by the actuator;

the magnetization direction of the bar magnets is perpendicular to the direction of the linear or rotational displacement; and

the magnetization direction of the bar magnets is opposite to each other.

A68. The valve assembly according to the preceding assembly embodiment and with the features of A30, wherein the actuator is configured to linearly or rotationally displace the bar magnets in a plane perpendicular to the central axis of the valve chamber, wherein the magnetization direction of the bar magnets is preferably parallel to the central axis of the valve chamber.

A69. The valve assembly according to any of the preceding assembly embodiments, wherein the force unit comprises at least one solenoid.

A70. The valve assembly according to the preceding assembly embodiment and with the features of assembly embodiment A12, wherein each of the at least one solenoid is fitted around at least a portion of the chamber body, respectively.

A71. The valve assembly according to the preceding assembly embodiment, wherein a rotational symmetry axis of the at least one solenoid coincides with the central axis of the valve chamber.

A72. The valve assembly according to any of the 3 preceding assembly embodiments, wherein the valve assembly is configured to switch a magnetization direction of the at least one solenoid.

A73. The valve assembly according to any of the 4 preceding assembly embodiments, wherein the at least one solenoid is two solenoids.

A74. The valve assembly according to the preceding assembly embodiments, wherein both solenoids provide the same magnetization direction.

A75. The valve assembly according to the penultimate assembly embodiment, wherein the two solenoids are configured to provide alternate magnetization directions, wherein only one solenoid may generate a magnetic field at a time.

A76. The valve assembly according to any of the preceding embodiments with the features of embodiment A69, wherein the at least one solenoid is configured to provide a magnetic flux density of at least 250 mT, preferably at least 500 mT, more preferably at least 700 mT.

A77. The valve assembly according to any of the preceding assembly embodiments, wherein at least one access to the valve chamber comprises a fitting for a connection to a capillary.

A78. The valve assembly according to any of the preceding assembly embodiments, wherein at least one access to the valve chamber is directly connected to a capillary.

A79. The valve assembly according to any of the preceding assembly embodiments, wherein the valve assembly further comprises a cavity.

A80. The valve assembly according to the preceding embodiment and with the features of embodiment A30, wherein the cavity comprises a central cavity axis which is aligned with the central axis of the valve chamber.

A81. The valve assembly according to the 2 preceding assembly embodiments, wherein the cavity is fluidly connected to the valve chamber through one of the accesses to the valve chamber.

A82. The valve assembly according to the preceding assembly embodiment, wherein the cavity is fluidly connected to a fitting configured to connect a capillary.

A83. The valve assembly according to any of the 2 preceding assembly embodiments, wherein the cavity is directly fluidly connected to a capillary.

A84. The valve assembly according to any of the 3 preceding assembly embodiments, wherein a portion of the sealing body assembly is located within the cavity.

A85. The valve assembly according to the preceding assembly embodiment, wherein the portion of the sealing body assembly located within the cavity comprises the magnetic portion of the sealing body assembly.

A86. The valve assembly according to any of the preceding assembly embodiments and with the features of A62, wherein the force unit is configured to selectively align one of the two bar magnets opposite to the magnetic portion in a plane perpendicular to the central axis.

A87. The valve assembly according to any of the preceding assembly embodiments, wherein the valve assembly is configured to operate at a pressure of up to 50 bar, preferably at a pressure of up to 100 bar, more preferably at a pressure of up to 400 bar, further preferably at a pressure of up to 800 bar.

A88. The valve assembly according to the any of the preceding assembly embodiments, wherein the valve assembly comprises a cover configured to encase at least a portion of the valve assembly.

A89. The valve assembly according to the preceding assembly embodiment, wherein the cover is configured to protect the encased portions of the valve assembly from environmental influences.

A90. The valve assembly according to any of the 2 preceding assembly embodiments, wherein the cover is configured as a shield for magnetic fields.

A91. The valve assembly according to the preceding assembly embodiment, wherein the cover is made of a ferrite or a ferromagnetic material.

A92. The valve assembly according to any of the 2 preceding assembly embodiments, wherein the cover is made of a soft-magnetic material.

A93. The valve assembly according to any of the 5 preceding assembly embodiments, wherein the cover encases at least a portion of the force unit and a portion of the valve chamber.

A94. The valve assembly according to any of the preceding assembly embodiments, wherein the movable sealing body assembly is not firmly attached to any other portion of the valve assembly.

A95. The valve assembly according to any of the preceding assembly embodiments, wherein at least a portion of the valve assembly is made from titanium, MP35N, ceramic, polyketone (PK), polyether ether ketone (PEEK) and/or austenitic stainless steel.

A96. The valve assembly according to the preceding embodiment, wherein the titanium is titanium Grade 5, such as 3.7164 or 3.7165.

A97. The valve assembly according to any of the 2 preceding assembly embodiments, wherein the austenitic stainless steel is one of 1.4404, 1.4435 or 1.4571.

A98. The valve assembly according to any of the preceding assembly embodiments, wherein the sealing portion is made of at least one of polyether ether ketone (PEEK), sapphire, ruby, aluminium oxide, zirconium dioxide, or silicon dioxide.

A99. The valve assembly according to any of the preceding assembly embodiments, wherein the sealing surface is made of at least one of polyether ether ketone (PEEK), sapphire, ruby, aluminium oxide, zirconium dioxide, or silicon dioxide.

Below, reference will be made to pump system embodiments. These embodiments are abbreviated by the letter “S” followed by a number. Whenever reference is herein made to “system embodiments”, these embodiments are meant.

S1. A pump system configured to provide a flow of fluid, wherein the system comprises

at least one pump unit;

an inlet valve configured to control a fluid flow at an inlet of at least one of the at least one pump unit; and

an outlet valve configured to control a fluid flow at an outlet of at least one of the at least one pump unit,

wherein at least one of the inlet valve and the outlet valve is a valve assembly according to any of the preceding assembly embodiments.

S2. The pump system according to the preceding system embodiment, wherein the at least one pump unit is a positive displacement pump unit.

S3. The pump system according to any of the 2 preceding system embodiments, wherein the at least one pump unit is a piston pump unit.

S4. The pump system according to any of the preceding system embodiments, wherein the pump system is configured to at least provide a flow of fluid with a flow rate in the range of 0.01 mL/min to 1 mL/min, preferably 0.005 mL/min to 5 mL/min, more preferably 0.001 mL/min to 10 mL/min.

S5. The pump system according to any of the preceding system embodiments, wherein the pump system is configured to operate at an output pressure of at least 50 bar, preferably at least 100 bar, more preferably at least 400 bar, even more preferably at least 800 bar.

S6. The pump system according to any of the preceding system embodiments, wherein the pump system comprises a plurality of pump units.

S7. The pump system according to the preceding system embodiment, wherein at least a subset of the plurality of pump units are fluidly connected in series.

S8. The pump system according to any of the 2 preceding system embodiments, wherein at least a subset of the plurality of pump units are fluidly connected in parallel.

S9. The pump system according to any of the preceding system embodiments, wherein the pump system is configured for reversing the flow through the pump system to purge the system.

Below, reference will be made to use embodiments. These embodiments are abbreviated by the letter “U” followed by a number. Whenever reference is herein made to “use embodiments”, these embodiments are meant.

U1. Use of the valve assembly according to any of the preceding assembly embodiments for controlling the flow of a fluid and/or use of the pump system according to any of the preceding pump system embodiments for providing a fluid flow.

U2. Use according to the preceding use embodiment in chromatography.

U3. Use according to the preceding use embodiment in liquid chromatography.

U4. Use according to the preceding use embodiment in high performance liquid chromatography.

U5. Use according to the preceding use embodiment in ultra-high performance liquid chromatography.

U6. Use according to any of the preceding use embodiments at a pressure exceeding 50 bar, preferably exceeding 100 bar, more preferably exceeding 400 bar, even more preferably exceeding 800 bar.

U7. Use according of a valve assembly according to any of the preceding use embodiments, wherein the valve assembly comprises the features of assembly embodiment A40 and wherein the use comprises actively switching the valve configuration to provide at the second access of the valve assembly a mixture of a fluid supplied at the first access and a fluid supplied at the third access.

Below, reference will be made to manufacturing method embodiments. These embodiments are abbreviated by the letter “P” followed by a number. Whenever reference is herein made to “manufacturing embodiments”, these embodiments are meant.

M1. Manufacturing method for manufacturing a valve assembly according to any of the preceding assembly embodiments.

M2. Manufacturing method according to the preceding manufacturing embodiment, wherein the manufacturing comprises calibrating the at least one sealing portion and/or the complementary sealing surface to provide an accurately fitting sealing contour.

M3. Manufacturing method according to the preceding manufacturing embodiment, wherein the step of calibrating comprises forming the sealing surface with a pre-press tool.

M4. Manufacturing method according to any of the 2 preceding manufacturing embodiments, wherein the at least one sealing portion and the complementary sealing surface comprise different degrees of hardness, and wherein the step of calibrating comprises applying a hydraulic pressure configured to press the sealing portion and the sealing surface together while the valve assembly is assembled.

M5. Manufacturing method according the preceding manufacturing embodiment, wherein the applied hydraulic pressure exceeds the smaller of the yield strength of the sealing portion and the yield strength of the sealing surface

M6. Manufacturing method according to any of the 2 preceding manufacturing embodiments, wherein the applied hydraulic pressure corresponds to a tension of at least 10 N/mm², preferably at least 50 N/mm², more preferably at least 100 N/mm².

A100. Valve assembly according to any of the preceding assembly embodiments, wherein the valve assembly is manufactured using the manufacturing method according to any of the preceding manufacturing embodiments.

Embodiments of the present invention will now be described with reference to the accompanying drawings. These embodiments should only exemplify, but not limit, the present invention.

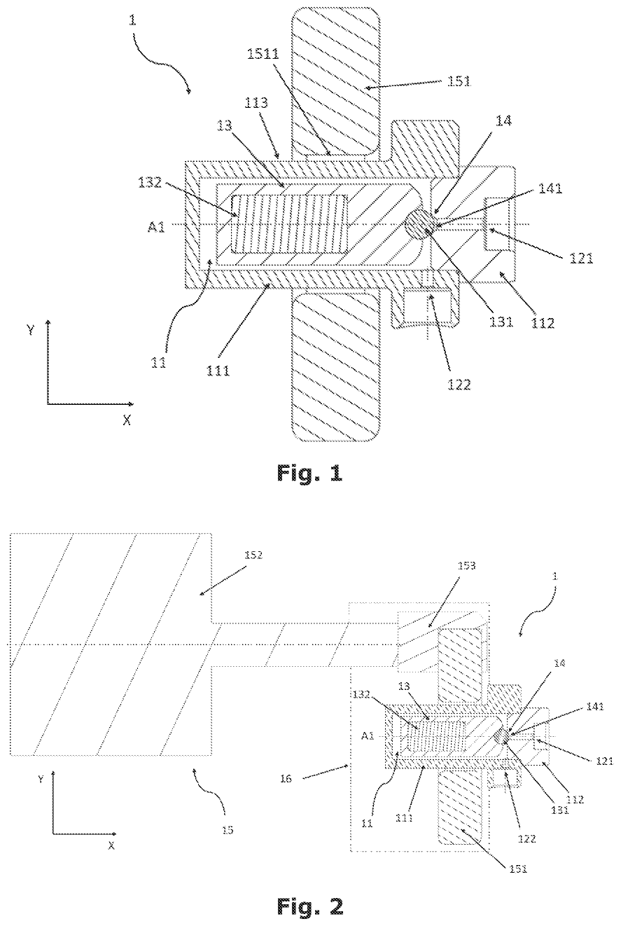

FIGS. 1 and 2 depict a valve assembly according to embodiments of the present invention;

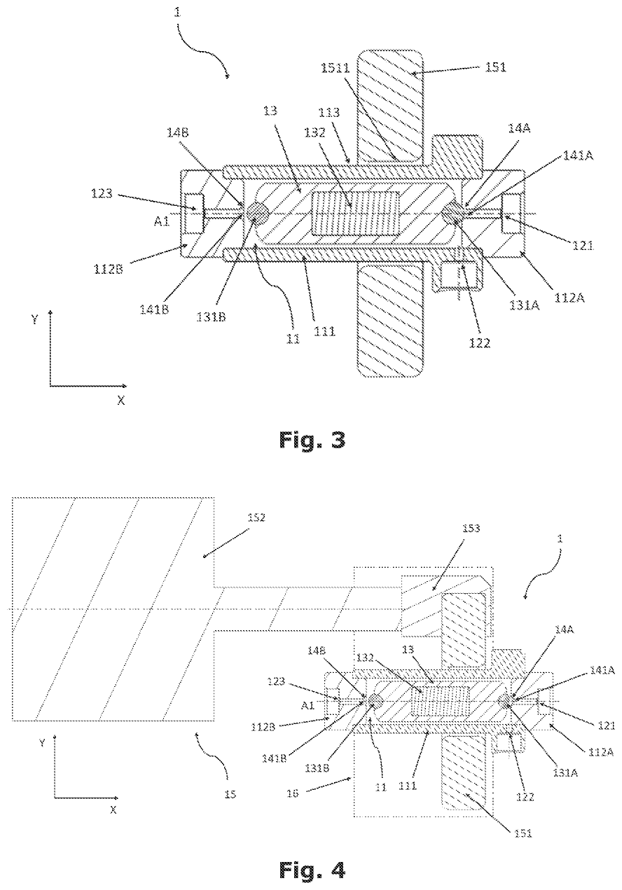

FIGS. 3 and 4 depict another valve assembly according to embodiments of the present invention;

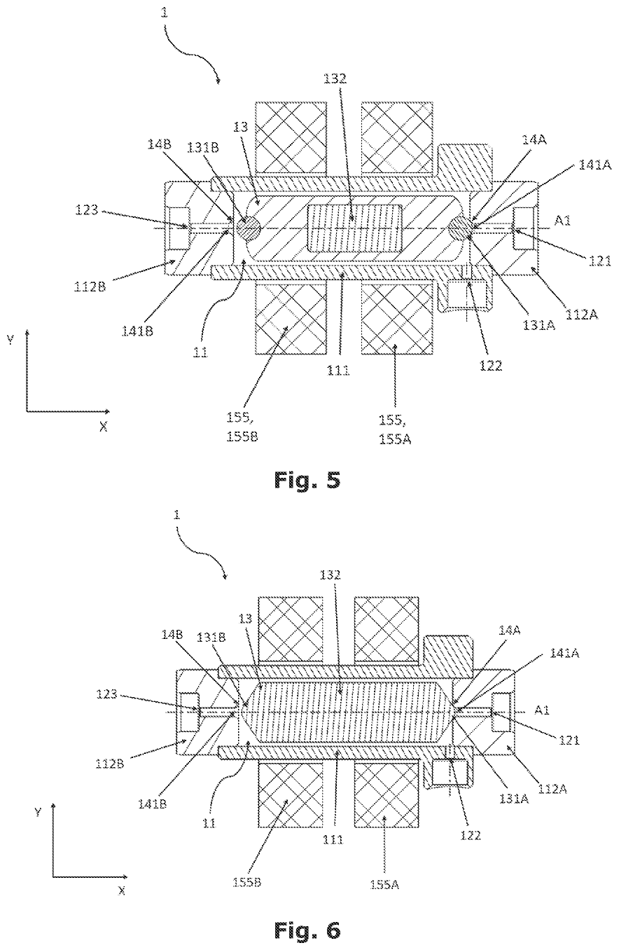

FIG. 5 depicts a further valve assembly according to embodiments of the present invention;

FIG. 6 depicts a further valve assembly according to embodiments of the present invention; and

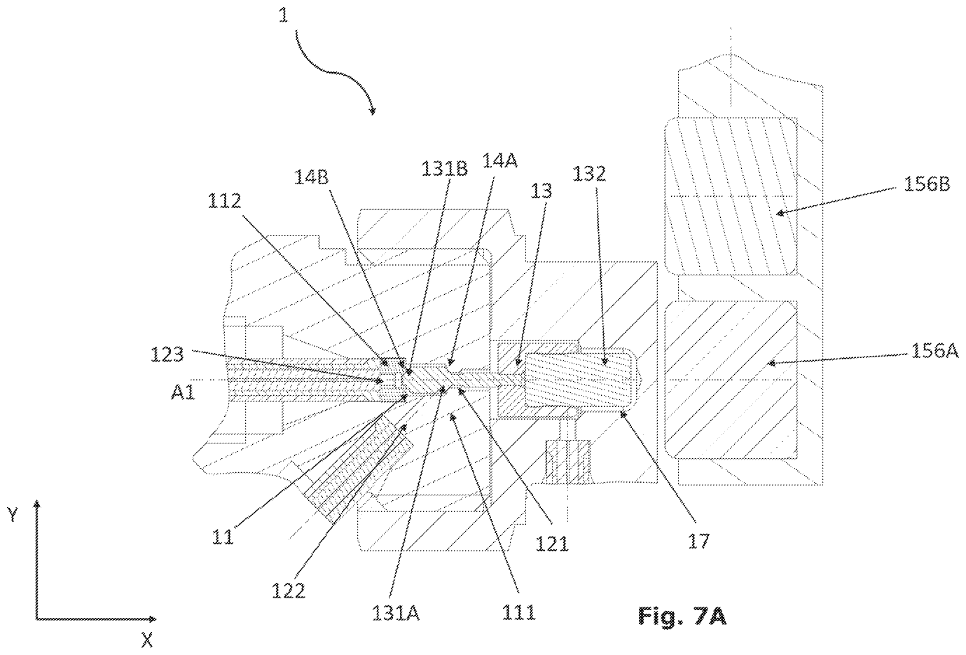

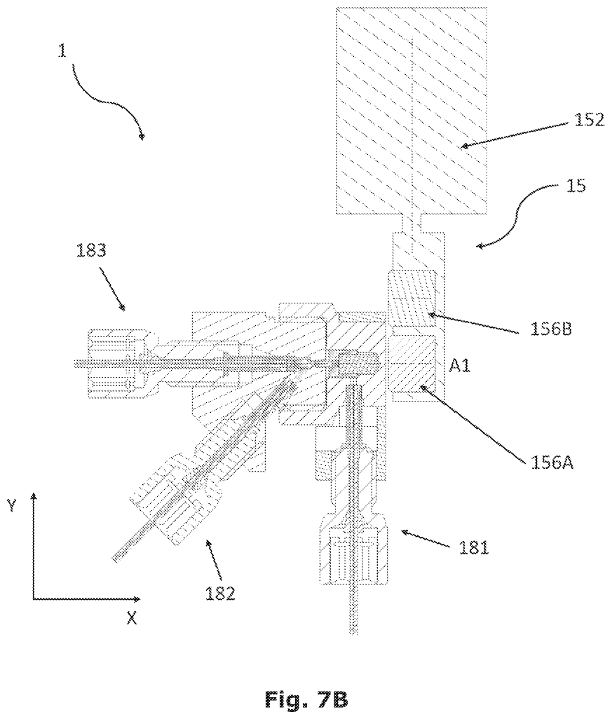

FIGS. 7A and 7B depict a still further valve assembly according to embodiments of the present invention.

It is noted that not all the drawings carry all the reference signs. Instead, in some of the drawings, some of the reference signs have been omitted for the sake of brevity and simplicity of the illustration.

In one embodiment, the invention relates to a valve assembly 1. Generally, the valve assembly 1 comprises a valve chamber 11, a plurality of accesses 121, 122 to the valve chamber 11, a movable sealing body assembly 13, at least one sealing surface 14 and a force unit 15.

The movable sealing body assembly 13 comprises at least one sealing portion 131 and at least a portion of the sealing body assembly 13 comprising the at least one sealing portion 131 is located within the valve chamber 11. That is, in some embodiments, the sealing body assembly 13 may be entirely located within the valve chamber 11, while in other embodiments only a portion of the sealing body assembly 13 may be located within the valve chamber 11. At least the portion of the sealing body assembly 13 comprising the at least one sealing portion 131 may be located within the valve chamber 11.

The valve chamber 11 may comprise a valve chamber volume. That is, the valve chamber may define a valve chamber volume, which may also be referred to as chamber volume. The chamber volume may be smaller than 500 μl, preferably smaller than 100 μl, more preferably smaller than 50 μl.

Consequently, the phrase “located within the valve chamber” refers to an object, e.g. part or portion, which is placed within the valve chamber volume. Thus, at least a portion of the movable sealing body assembly 13 is located within the valve chamber volume and in particular the at least one sealing portion 131 is located within the valve chamber volume.

Particularly, the at least a portion of the sealing body assembly 13 located within the chamber volume is located such that it is movable within the valve chamber 11. That is, the at least a portion of the sealing body assembly 13 may not fill the chamber volume completely. In other words, the at least a portion of the sealing body assembly 13 may be movable within the valve chamber 11, e.g., along at least one axis. However, the flushed volume of the valve chamber 11, i.e. the volume of the valve chamber, which is not filled with a portion of the sealing body assembly, may advantageously be minimized. In other words, the dead volume of the vale chamber 11 may advantageously be small, e.g. compared to utilizing a double check valve at the outlet of a pump.

Further, the sealing body assembly 13 may comprise a magnetic portion 132, i.e. at least a portion of the sealing body assembly 13 may be magnetic. The magnetic portion 132 may for example comprise a ferrite or a ferromagnetic material, such as an iron, cobalt and/or nickel alloys (e.g. alnico) or Nd₂Fe₁₄B (Neodymium magnet). Thus, generally the magnetic portion may comprise a soft- or a hard-magnetic material. Consequently, it may form a permanent or a non-permanent magnet. It will be understood that hard magnetic materials may be permanently magnetic and soft magnetic materials may be easily magnetised and demagnetised. In some embodiments, the sealing body assembly may preferably comprise a hard-magnetic material.

Each of the at least one sealing surface 14 may be configured to complement one of the at least one sealing portion 131. Further, each of the at least one sealing surface 14 may comprise an orifice 141 fluidly connected to one of the accesses 121, 122, 123 to the valve chamber. In other words, the at least one sealing surface 14 may be configured such that it may form a leak-tight connection with the corresponding sealing portion 131 of the sealing body assembly 13 and thus substantially prevent flow of a fluid through the orifice 141 of the sealing surface 14. That is, the sealing surface 14 may for example be formed to accommodate at least a portion of the corresponding sealing portion 131 to form a leak-tight connection and thus block the orifice 141 comprised by the sealing surface 14.

The phrase “forming a leak-tight connection” may refer to providing a sealed connection. Generally, the sealing surface 14 and the sealing portion 131 may form a sealing interface when in contact with each other and said sealing interface may be such that substantially no fluid may leak through. Thus, the sealing surface 14 and the sealing portion 131 may form a leak-tight connection. However, it will be understood, that the leak-tight connection is generally substantially leak-tight. That is, it may still comprise a residual leak rate, which may be less than or equal to 100 nl/min, preferably less than or equal to 50 nl/min, more preferably less than or equal to 5 nl/min.

Generally, it may be desirable to minimize the area of the sealing interface, i.e. the projected surface between the sealing portion 131 and the sealing surface 14.

In order to ensure a leak-tight connection between the sealing portion 131 and the sealing surface 14, the sealing portion 131 and the sealing surface 14 may be calibrated with respect to each other, e.g. as part of the manufacturing process. In other words, there may be a one-off hydraulic calibration of the sealing surface 14 and/or the sealing portion 131, e.g. during production. The calibration may for example comprise pressing a geometry that is at least similar to the sealing portion 131 into the sealing surface 14 either by means of a pre-press tool or for example by applying a hydraulic pressure that presses the sealing portion 131 into the sealing surface 14, when in an assembled state. Therefore, preferably either the sealing surface 14 or the sealing portion 131 may comprise a softer material than the respective other portion, such that during the calibration the softer material may be formed to provide a leak-tight sealing interface between the sealing portion 131 and the sealing surface 14. In other words, the hardness of the sealing portion 131 may be different compared to the hardness of the sealing surface. Thus, they may be calibrated, e.g. moulded, with respect to each other by applying a hydraulic pressure that presses them together, e.g. when in an assembled state, at which point the harder portion (i.e. the sealing portion 131 or the sealing surface 14) may deform the respective other portion, such that they form a calibrated sealing interface. In other words, the soft sealing portion 131 or respectively sealing surface 14 is calibrated, e.g. moulded, by the hard sealing surface 14 or respectively sealing portion 131.

The force unit 15 may generally be configured to exert a force on the magnetic portion 132 of the movable sealing body assembly 13. For example, the force unit 15 may force the sealing body assembly 13, and thus the sealing portion 131, towards one of the at least one sealing surface 14 to block the orifice 141 comprised by said sealing surface 14. Similarly, it may for example exert a force in the opposite direction, thus preventing the sealing portion 131 from blocking the respective orifice 141 in the corresponding sealing surface 14. In other words, the force unit 15 may exert a force on the magnetic portion 132 of the sealing body assembly 13, which may enable active opening and closing of at least one access 121, 122, 123 to the valve chamber 11. This may generally provide certain advantages: it may allow for faster switching than with purely gravity or liquid flow driven check valves, i.e. passive check valves. Furthermore, such a valve assembly 1 may even open against a pressure that would otherwise keep the sealing portion 131 pressed against the respective sealing surface 14 such that the orifice 141 remains blocked. Particularly, the described valve assembly 1 may allow to actively change the configuration assumed by the valve assembly, which may be more reliable than for passive check valves, particularly in the presence of gluing and/or setting effects.

Generally, the valve assembly 1 may be configured to assume at least two configurations, wherein in the first configuration I, a first access 121 is sealed and wherein in the second configuration II the first access 121 is fluidly connected to a second access 122. In other words, the valve assembly 1 may assume a first configuration I wherein a flow path between the first access 121 and the second access 122 is blocked and a second configuration II, wherein a fluid may flow between the first access 121 and the second access 122. Thus, the first configuration I may also be referred to as closed configuration and the second configuration II may be referred to as open configuration. In the open configuration a fluid may in some embodiments flow in any direction, i.e. from the first access 121 to the second access 122 or vice versa.

Reference will now be made to FIG. 1, which schematically depicts an exemplary embodiment of a valve assembly 1 according to the present invention. In particular, an exemplary 2/1-way valve according to the present invention is shown. That is, a valve with 2 fluidic connections (accesses 121, 122) and 1 way of connecting these two.

The valve assembly 1 comprises a valve chamber 11, which may for example be formed by a chamber body 111. The chamber body 111 or at least a portion thereof may be at least substantially non-ferromagnetic. That is, it may preferably be made from non-ferromagnetic material, e.g. titanium, PEEK or MP35N. It may also be possible to use PEEK within another material. That is, the chamber body may for example be made of stainless steel or another material and subsequently be injected with PEEK, such that an inner surface defining the chamber volume would for example be formed by PEEK. However, the term “substantially” is meant to include also very weakly ferromagnetic materials, which may not restrict the functionality of the valve assembly. In particular, materials may qualify as weakly ferromagnetic if they only experience negligible forces in the magnetic fields provided by the force unit 15 in comparison to the magnetic portion 132.

The chamber body 111 may comprise at least one opening through which it may for example receive the at least a portion of the sealing body assembly 13 that is located within the valve chamber 11. The opening may be fitted with a chamber seal 112. For example, once the at least a portion of the sealing body assembly 13 is placed within the valve chamber 11, each of the at least one opening may be fitted with a chamber seal 112. The chamber seal 112 may generally be designed to withstand typical pressures of applications in HPLC, that is the chamber seal 112 may withstand static pressures of at least 50 bar, preferably at least 100 bar, more preferably at least 400 bar, further preferably 800 bar.

The depicted embodiment comprises two accesses 121, 122 to the valve chamber 11. The first access 121 is provided by a channel through the chamber seal 112, while the second access is provided by a channel through the chamber body 111. Thus, the depicted valve assembly comprises two fluidic connections which may be fluidly connected through the valve chamber 11. However, it will be understood that for example also the first access 121 may be provided by a channel through the chamber body 111 and/or the second access 122 may be provided through the chamber seal 112. Generally, each access may be fluidly connected to a socket configured to receive a respective fluidic connector, allowing to directly connect the access to a respective capillary.

Furthermore, the valve chamber 11 comprises the movable sealing body assembly 13, which comprises a magnetic portion 132. The magnetic portion 132 may for example be completely or partially surrounded by an exterior portion of the sealing body assembly 13. That is, generally it may be comprised by one or more other portions of the sealing body assembly 13, such that it cannot get into contact with any liquid within the valve chamber 11. Furthermore, the sealing body assembly comprises a sealing portion 131, which may be designed to be accommodated by a complementary sealing surface 14 which may surround the channel of the first access 121. That is, the sealing portion 131 and the sealing surface 14 may be designed such that they can form a leak-tight connection and thus block a fluid flow through the first access 121.

In the depicted embodiment in FIG. 1, the sealing portion 131 of the sealing body assembly 13 is a sphere 131 which is attached to the remaining sealing body assembly 13. However, the sealing portion 131 may also assume different shapes and/or be integrally formed with the remaining sealing body assembly 13.

The sealing surface 14 may for example be comprised by the chamber seal 112 and designed such that the orifice 141 comprised by the sealing surface 14 is fluidly connected to the first access 121. The sealing surface 14 may be shaped to accommodate at least part of the sealing portion 131. In other words, it may be complementary to the sealing portion 131. Thus, the sealing portion 131 and the sealing surface 14 may provide a leak-tight connection when pressed onto each other. In some embodiments, the hardness of the sealing portion 131 and the sealing surface 14 may be different to allow for a calibration, e.g. by applying a high pressure, which may press the sealing portion 131 into the sealing surface 14 when in an assembled state.

Generally, the movable sealing body assembly 13 may preferably be moved along a central axis A1 of the valve chamber 11. The central axis A1 may run centrally through two opposing sides of the valve chamber 11 and preferably in the direction of its largest extent. That is, the central axis A1 may run through the centre of two opposing sides of the valve chamber 11, which may preferably be oriented such that the central axis A1 runs in the direction of the largest extent of the valve chamber 11. Preferably, the sealing portion 131 and the sealing surface 14 may both lie on the central axis A1. Generally, the sealing portion 131 and the sealing surface 14, and particularly the orifice 141 comprised thereby, may be aligned such that the sealing portions 131 may be moved between a position in which the sealing portion 131 and the sealing surface 14 form a leak-tight connection, blocking the orifice 141 comprised by the sealing surface 14 and a position wherein the sealing portion 131 is not in contact with the sealing surface 14 such that the orifice is fluidly connected to the chamber volume. It will be understood that the sealing portion 131 and the respective sealing surface 14 may preferably be in alignment, such that the sealing portion 131 may block the orifice 141 comprised by the sealing surface 14 in a sealing manner. Consequently, the sealing surface 14 and the sealing portion 131 may lie on the central axis A1 along which the movable sealing body assembly 13 may preferably be moved. In some embodiments, the valve chamber 11 may be rotationally symmetric around the central axis A1. Generally, if a portion is said “to lie on the axis”, this refers to the geometrical centre of said portion coinciding with the axis.

The second access 122 to the valve chamber 11 may be oriented such that it may not be blocked by the movable sealing body assembly 13. Therefore, the valve assembly 1 may in principle be similar to a passive check valve, wherein the first access 121 would be the inlet and the second access 122 would be the outlet. That is, generally, the valve assembly 1 provides a functionality similar to a passive check valve. However, the valve assembly 1 further comprises a force unit 15, which may actively exert a force on the sealing body assembly 13. By setting this force, one may for example determine at which pressure differential the valve opens.

In particular, the force unit 15 may exert a magnetic force on the magnetic portion 132 of the sealing body assembly 13, which may for example suffice to move the sealing body assembly 13. Thus, the force unit 15 may actively apply a force and for example, move the sealing body assembly 13 and particularly the sealing portion 131 towards, or away from, the sealing surface 14. Preferably, the force unit 15 may move the movable sealing body assembly 13 along the central axis A1, that is, in a direction parallel (or identical) to the central axis A1. The force unit 15 may therefore at least aid with changing the configuration the valve assembly 1 may assume, e.g. open or closed.

For example, the force unit 15 may comprise a permanent annular magnet 151, such as a ring magnet 151, which may be fitted around the valve chamber 11 and/or the chamber body 113. In other words, the valve chamber 11 may pass through the central opening of the annular magnet 151. Further, the annular magnet 151 may be movable with respect to the valve chamber 11. Preferably, the space between the inner surface of the annular magnet 1511, i.e. the surface within the opening, and an outer surface of the chamber body 113 is minimized, while maintaining enough space to allow for a relative movement of the annular magnet 151 to the valve chamber 11. This may be advantageous for minimizing the overall size of the valve assembly 1, as well as for providing a strong and homogenous magnetic field around the central axis A1 of the valve chamber 11, which may preferably run through the centre of the annular magnet 151.

The annular magnet 151 may comprise an axial magnetization direction along its rotational symmetry axis. That is, in the centre of the annular magnet, the magnetic field may be oriented along the axis around which the annular magnet is rotationally symmetric, i.e. the rotational symmetry axis. In other words, the magnetic field in the centre of the annular magnet may be oriented along the rotational symmetry axis of the annular magnet 151, i.e. perpendicular to the diameter of the annular magnet 151. Thus, the magnetization direction of the annular magnet 151 may preferably coincide with the central axis A1. Further, the central axis A1 may coincide with the rotational symmetry axis of the annular magnet 151.

The annular magnet 151 may either exert a repulsive or an attractive magnetic force onto the magnetic portion 132 of the sealing body assembly 13. More particularly, the magnetic portion 132 may generally be driven towards a relative position with respect to the annular magnet 151 that leads to an equilibrium between repulsion and attraction, which corresponds to a force equilibrium. Thus, by moving the annular magnet 151, the sealing body assembly 13 may be moved and particularly the sealing portion 131 may be forced towards (or away from) the sealing surface 14. The direction of the force directly depends on the direction of the magnetic field and thus on the orientation of the magnetic poles of the annular magnet 151, as well as on the orientation and position of the magnetic portion 132 relative to the annular magnet 151. Therefore, the annular magnet 151, and thus the force unit 15, may advantageously allow for exerting a force onto the sealing body assembly 13 without the need of a mechanical link therebetween, i.e. contactless.

For example, in the embodiment depicted in FIG. 1, the annular magnet 151 may be oriented such that the magnetic field attracts the magnetic portion 132 of the sealing body assembly 13. Therefore, the resulting magnetic force may push the sealing body assembly 13 towards the sealing surface 14. Consequently, the sealing portion 131 of the sealing body assembly 13 may be received by and pressed into the sealing surface to form a leak-tight connection. Thus, the fluidic connection between the valve chamber 11 and the first access 121 may be blocked and the valve may assume the first (closed) configuration I.

The valve assembly 1 may be configured such that the closed position can be maintained for a pressure difference between the first access 121 and the valve chamber 11 of up to a differential pressure threshold of at least 20 bar, preferably at least 50 bar, more preferably at least 100 bar, wherein the higher pressure is present at the first access 121. It will be understood by the person skilled in the art that if the higher pressure is present in the valve chamber 11, e.g. by a pressurized fluid supplied at the second access 122, the valve assembly 1 may generally stay in the closed configuration, similarly to a passive check valve. However, if a fluid flow from the second access 122 to the first access 121 is desirable, the force unit 15 may apply a force to move the sealing body assembly 13 away from the sealing surface 14. For example, the annular magnet 151 may be moved away from the chamber seal 112 (in negative x-direction), forcing the sealing body assembly 131 away from the sealing surface 14. The valve assembly 1 may be configured such that the valve assembly 1 can be moved into the second (open) configuration II by means of the force unit 15 provided the pressure difference does not exceed the differential pressure threshold, wherein in this moment the higher pressure is present in the valve chamber 11. This may be advantageous for purging a pump the valve assembly may be fitted to.

Generally, it will be understood that when reference is made to a pressure difference, e.g. between an access and the valve chamber or two accesses, the pressure difference of the fluids comprised by (or supplied to) these portions is meant.

That is, generally the valve may operate similar to a passive check valve, wherein the valve assembly may change its configuration based on the pressure difference between the first access 121 and the second access 122. However, the threshold for the pressure difference at which the configuration may be changed is altered by the magnetic force acting on the movable sealing body 13. That is, while for a passive check valve the presence of a pressure difference may already suffice to change the configuration of the valve, the pressure difference needs to be high enough to provide a force higher than the magnetic force exerted on the movable portion 13 to change the configuration. In other words, the valve may be magnetically preloaded (similarly to a passive check valve preloaded by means of a spring). Such a valve may for example advantageously be used as pump discharge valve. Similarly, the valve may also change its configuration prior to reaching the pressure that would be necessary to open a passive check valve, that is as soon as the differential pressure is within the differential pressure threshold.

That is, the force unit may support the opening and closing of the valve assembly in said conditions by providing a magnetic force that pushes the movable sealing body assembly in the desired direction. However, in addition the force unit may actively open and close the valve also against a pressure difference of at least up to the differential pressure threshold. Thus, the valve may stay closed even if the higher pressure is present at the first access and similarly it may be opened even if the higher pressure is present in the valve chamber 11, provided that the pressure difference is below the limit specified above.

In other words, a valve assembly according to the present invention may advantageously allow active switching at high pressure, provided that the differential pressure does not exceed the differential pressure threshold. Thus, a reversal of the flow may also be possible at high system pressures. For example, switching at 800 bar and a differential pressure of 50 bar has been performed with a valve according to the present invention for 100,000 switching cycles, further showing the durability of the design.

Therefore, a valve according to embodiments of the present invention may allow for pre-compression of a fluid even above the pressure level of the valve chamber, e.g. prior to injection. That is, due to the possibility to actively prevent opening of the valve at least up to the differential pressure threshold, a fluid may be brought up to a pressure that is higher than the pressure within the valve chamber, which may for example allow for precise injection of a plug and/or prevent any backflow when the valve is opening. However, it will be understood that the valve may similarly be opened prior to reaching the pressure of the valve chamber, as long as the pressure difference is within the pressure difference threshold.

The force unit 15 is discussed in more detail with respect to FIG. 2. The force unit 15 may comprise a permanent annular magnet 151, an actuator 152 and a coupling unit 153. The actuator 152 may be configured to provide a linear motion which may be transmitted to the annular magnet 151 via a coupling unit 153. Generally, the linear motion provided by the actuator 152 may be coupled to the annular magnet 151 such that the annular magnet 151 can be moved back and forth with respect to the valve chamber 11, i.e. along an axis running through the valve chamber 11 in x-direction. Preferably it may be moved along the central axis A1 on which the sealing portion 131 and the sealing surface 14 preferably lie. For example, the actuator 152 may be a linear solenoid, a lifting solenoid or a linear motor.

In other words, the actuator 152 may transform an electrical signal into a mechanical motion, which may be transferred to the annular magnet 151 by means of a coupling unit 153. When the annular magnet 151 is moved such that its position changes relative to the magnetic portion 132 of the movable sealing body assembly 13, a magnetic force may be exerted onto the movable sealing body assembly 13, which may result in a movement of the magnetic sealing body assembly 13 or in a biasing thereof, i.e. the sealing portion 131 may be biased, e.g. pressed, against the sealing surface 14.

The guidance of the annular magnet 151, which may be moved relative to the valve chamber by means of the actuator 152, may be provided for example through the interaction of the inner surface of the annular magnet 1511 and the outer surface of the chamber body 113 and/or by the actuator 152 and/or coupling unit 153 connected to the annular magnet.

In other words, active displacement of the outer annular magnet 151 may be provided by a basic actuator 152, e.g. an electromagnetic lifting solenoid, which can easily be coupled to the annular magnet 151. The coupling unit 153 may transmit a push and/or pull motion which may depend on how the active check valve functions, e.g. as an inlet or outlet valve.

For example, when the first access 121 is an inlet and the second access 122 is an outlet, the valve assembly functions as an inlet valve. In this case, the actuator 152 “pushes” the sealing body assembly 13 into a sealing engagement with sealing surface 14, and for example only opens when a pressure difference between the first access 121 and the second access 122 exceeds a threshold.

Conversely, when the first access 121 is an outlet and the second access 122 is an inlet, the actuator 152 may be actuated in such a way as to “open” the valve assembly under certain conditions (e.g., in case a pressure difference is sensed and/or at defined times), i.e., provide a “pulling” force to open the valve assembly under these conditions.

It will be understood that the description of the force unit 15 provided above merely serves as an example and that different embodiments may also be realised. That is, not every embodiment of the force unit 15 may comprise an annular magnet 151, an actuator 152 and/or a coupling unit 153. For example, the annular magnet 151 may be directly connected to the actuator 152, i.e. without a coupling unit 153. Similarly, the basing unit 15 may instead comprise at least one solenoid 155, which may exert a force onto the sealing body assembly 13 via the magnetic portion 132 and which may simply change the direction of the applied force by reversing the direction of the current flow through the (coil of the) solenoid 155. Such an implementation would for example neither require an actuator 15, nor a coupling unit 153 for providing mechanical motion. Thus, it will be apparent for the person skilled in the art that a variety of force units 15 may be realized, which may be configured to exert a force on the magnetic portion 132 of the movable sealing body assembly 13.

Further, at least a portion of the valve assembly 1 may be surrounded by a cover 16, configured to shield the magnetic field and/or to protect at least a portion of the valve assembly 1 from environmental influences such as contamination, e.g. dust or dirt. For example, the cover 16 may encase the annular magnet 151 and the portion of the valve chamber 11 around which the annular magnet 151 may be moved. Generally, the cover 16 may preferably at least encase the portion of the force unit 15 providing (e.g. generating) the magnetic field that directly acts on the magnetic portion 132 of the valve assembly 1, e.g. the annular magnet 151 or an solenoid 155, which are fitted around at least a portion of the valve chamber 11 and/or the chamber body 131. The cover 16 may be made from a ferrite or a ferromagnetic material and it may preferably be designed such that the magnetic field inside is directed directly and homogeneously into the valve chamber 11. In other words, an outer cover 16, preferably made of ferrite or ferromagnetic material, may serve as an outer shield for the magnetic field and as protection against environmental influences such as contamination.

With reference to FIG. 3 for example also a 3/2-way valve may be realized in a similar way. The valve assembly 1 also comprises a valve chamber 11 formed by a chamber body 111 and in this case two chamber seals 112A, 112B. The two chamber seals 112A, 112B may preferably be placed at opposite ends of the chamber body 111. Each of the two chamber seals 112A, 112B may comprise an access to the valve chamber 121, 123, i.e. one chamber seal 112A may comprise the first access 121 and the other chamber seal 112B may comprise a third access 123. The second access 122 may for example be in a similar position as for the embodiment discussed with reference to FIG. 1. That is, it may be in the chamber body 111. Such a valve chamber may advantageously not comprise a dead volume as the chamber can be flushed by subsequently opening the first access 121 and the third access 123. In contrast an embodiment such as the one depicted in FIG. 1 may comprise dead volume as the portion of the chamber opposite to the first access may not be directly flushed independent of the configuration assumed by the valve.

The valve assembly 1 may comprise a corresponding sealing surface 14A and 14B for the first access 121 and the third access 123, respectively, which may be located within the valve chamber 11. Further, each of the sealing surfaces 14A and 14B may comprise an orifice 141A, 141B fluidly connecting the valve chamber 11 to the respective access 121, 123. The sealing surfaces 14A and 14B may each be comprised by one of the chamber seals 112A, 112B.

Within the valve chamber 11 may be the sealing body assembly 13 which may comprise a magnetic portion 132, such as a magnetic core made of ferromagnetic material, e.g. a bar magnet. Further, the sealing body assembly 13 may comprise two sealing portions 131A, 131B. The sealing body assembly 13 and particularly the sealing portions 131A, 131B may be placed within the valve chamber 11 such that each sealing portion 131A, 131B may be aligned with the complementary sealing surface 14A, 14B. Preferably, the sealing portions 131A, 131B may be located at opposite ends of the sealing body assembly 13 and consequently, the sealing surfaces 14A, 14B may be located at opposite ends of the valve chamber 11, e.g. each in one of the chamber seals 112A, 112B which may be at opposite ends of the valve chamber 11. The sealing portions 131A, 131B and the sealing surfaces 14A, 14B may preferably be aligned along the central axis A1. Further, the sealing body assembly 13 may move along that central axis A1, i.e. the sealing body assembly 13 may move in a direction parallel to the central axis A1. In the depicted embodiment this is the X-direction.

The sealing body assembly 13 may be configured such that it can move within the valve chamber 11. In particular, it may be configured such that it may not fill the entire chamber volume. Particularly, the sealing body assembly 13 may be configured such that at most one sealing portion 131A, 131B can form a leak-tight connection with the corresponding sealing surface 14A, 14B at the same time. Thus, the valve assembly 1 may assume a first configuration I, wherein the first access 121 is sealed and the third access 123 is fluidly connected to the second access 122. For example, the sealing portion 131A and the sealing surface 14A may form a leak-tight connection to block the fluidic connection between the valve chamber 11 and the first access 121. In the first configuration I, the third access 123 may not be blocked by the sealing body assembly 13. Furthermore, the valve assembly 1 may assume a second configuration II, wherein the third access 123 is sealed and the first access 121 is fluidly connected to the second access 122. In addition, the valve assembly 1 may assume a third configuration III, wherein the first 121, second 122 and third 123 access may be fluidly connected to each other via the valve chamber 11.

Thus, the valve assembly 1 according to the embodiment depicted in FIG. 3 may selectively connect the first access 121 or the third access 123 to the second access 122. The basic principle is similar to a passive 3/2-way check valve, i.e. a pressure difference between the first 121 (or third 123) access and the valve chamber 11 may principally move the sealing body assembly 13 and thus alter the configuration the valve assembly assumes. However, the switching characteristics of the valve assembly 1 may be altered by a force exerted onto the sealing body assembly 13 through the force unit 15.

An active 3/2-valve according to the present invention may for example advantageously be used as proportioning valve. That is, the first access 121 and the third access 123 may for example each be connected to a solvent supply, such that a desired solvent combination, e.g. mixture, may be provided at the second access. In particular, the valve 1 may alternately open (and close) the first and third access such that a desired mixture of the respective solvents is supplied at the second access 122. Embodiments of the present invention may particularly allow for fast and reliable switching such that a mixing of the solvents may be achieved within the valve chamber 11. In other words, an active 3/2-valve according to the present invention may advantageously be used as a mixing valve.

As described above, the force unit 15 may comprise an annular magnet 151 which may exert a force onto the sealing body assembly 13 (when annular magnet 151 and sealing body assembly are not in a relative position that leads to an equilibrium of forces therebetween). This force may be sufficient to open and/or close (i.e. block) a desired access (e.g. of the first 121 and third access 123), even against a pressure difference. For example, if there is a pressure difference between the first access 121 and the valve chamber 11, wherein the pressure is lower in the valve chamber than in the first access 121, the sealing body assembly 13 would generally be pushed away from the first access 121 and a fluid connection between the first access 121 and at least the second access 122 would be established. However, by applying a force that pushes the sealing body assembly 13 towards the first access 121 and more particular against the corresponding sealing surface 14A, the first access 121 may remain blocked even when a pressure difference exists. Further, the first access may be opened even though the valve chamber 11 is at a higher pressure than the first access 121 by applying a force with the force unit 15 that pushes the sealing body assembly 13 away from the first access 121 and the respective sealing surface 14. This may be particularly useful for purging or backflushing any component fluidly connected to the first access 121, e.g. a pump. Again, the pressure difference that may be overcome may be limited to pressure differences below, or equal to the differential pressure threshold. The above may generally also apply for the third access 123.

It will be understood that a pressure difference between the first access 121 and the third access 123 may consequently reflect a pressure difference between one of the accesses and the valve chamber 11, because at least one of the two access 121, 123 may always be fluidly connected to the valve chamber 11. In other words, if the first access 121 is supplied with a fluid at a higher pressure than the third access 123, the sealing body assembly 13 would be pushed towards the third access 123 and potentially seal the third access 123. Thus, the valve chamber 11 would be pressurized to approximately the pressure at the first fluid supply 121. If the pressure difference is within the boundaries that may be overcome by the force unit 15, i.e. if the pressure difference is not greater than the differential pressure threshold, the valve assembly may actively open the third access 123 and close the first access by exerting a force to the sealing body assembly 13 that pushes it towards the first access 121.

With reference to FIG. 4, the force unit 15 of the valve assembly 1 may comprise an annular magnet 151, an actuator 152 and a coupling unit 153, wherein the actuator 152 may be configured to provide a linear motion that may be transmitted to the annular magnet 151 by means of a coupling unit 153. The linear motion may be provided such that the annular magnet may be moved with respect to the valve chamber 11 in the x-direction, i.e. along the central axis A1.

Further, the valve assembly 1 may preferably comprise a cover 16, which may encase at least a portion of the valve assembly 1. The cover 16 may be configured to protect the encased portions of the valve assembly 1 from environmental influences, e.g. contamination, and/or to act as a shield for magnetic fields, e.g. originating from the annular magnet 151. Thus, the cover 16 may preferably be made out of a ferrite or a ferromagnetic material and for example be cylindrically shaped. Preferably, the cover 16 may at least encase the portion of the force unit 15 providing (e.g. generating) the magnetic field that directly acts on the magnetic portion 132 of the valve assembly 1, e.g. the annular magnet 151 or an solenoid fitted around at least a portion of the valve chamber 11 and/or the chamber body 131. In case the force unit 15 comprises moving portions, the cover 16 may further encase at least the portion of the valve chamber 11 along which the magnetic-field-providing portion of the force unit 15, e.g. the annular magnet 151, may be moved (e.g. through the actuator 152).

Again, it will be understood that the above description merely concerns an exemplary embodiment of the valve assembly 1 and particularly the force unit 15 and that other embodiments may also be realised within the scope of the present invention. It will be apparent for the person skilled in the art that also other embodiments of the force unit 15 may be realized, wherein the force unit 15 may be configured to exert a force on the magnetic portion 132 of the movable sealing body assembly 13.

Generally, the chamber body 111 of the valve chamber 11 may for example be a pressure-resistant tube, configured to withstand typical pressures and liquids used in HPLC. The ends of the pressure-resistant tube may be sealed by means of corresponding chamber seals 112. Further, the sealing portion 131 of the sealing body assembly 13 may for example be a one-sided tip, which may be configured to form a leak-tight connection to the at least one sealing surface 14, which may also be referred to as sealing seat. The at least one sealing surface 14 may for example be comprised by a respective chamber seal 112.

Thus, a valve assembly in a 2/1-way or 3/2-way version may for example be constructed as follows: In a pressure-resistant tube comprising a corresponding wall thickness, which may be made of a material resistant to liquids used in HPLC, e.g. chemically inert (such as low or no iron content), and non-ferromagnetic (e.g. titanium, more particularly titanium grade 5 (3.7164/3.7165), or MP35N), and at the ends of which a high-pressure static seal is fitted, there may be a translationally movable sealing body assembly 13 with a permanent magnetic portion 132, e.g. a cylindrical core. The outside, e.g. outer shell, of the movable sealing body assembly 13 may also be mechanical and chemical resistant to the surrounding liquid pressure and the typical liquids used. The movable sealing body assembly 13 may comprise at least one sealing portion 131, e.g. one-sided tip, which in turn may seal against a corresponding sealing surface 14, also referred to as sealing seat, in the chamber body 111 or the chamber sealing 112.

Further, an active force coupling to the (at least partially permanent magnetic) movable sealing body assembly 13 may be realized with an outer permanent magnetic annular magnet 151, which may be designed such that a gap to the outer diameter of the pressure-resistant and non-ferromagnetic tube, i.e. the chamber body 111, is minimized. By active, predominantly axial displacement of the outer annular magnet 151, the inner sealing body assembly 13 may be pressed onto or pushed away from the sealing surface 14 (e.g. into or out of the sealing seat).

Through an initial calibration, e.g. by applying high hydraulic pressure, for example the softer sealing portion 131 (e.g. tip) may be formed by the harder sealing surface 14 (e.g. sealing seat) in such a way that a very precise (fitting) sealing contour may be produced, which in turn may provide a leak-tight seal in the desired direction.

It will be understood that for this process it may generally not be relevant whether the movable sealing body assembly 13, particularly the corresponding sealing portion 131, or the sealing surface 14 (e.g. the sealing seat) is made of a slightly harder material. That is, primarily the presence of a difference in the (degree of) hardness of the material matters. However, there may still be other considerations that lead to a portion being preferably the harder/softer portion, e.g. it may be preferably that the moving portion, i.e. the sealing portion 131 is harder than the sealing surface 14, which is generally fixedly mounted.

Some more examples for embodiments of the valve assembly may be discussed in the following, however, it will be understood that theses merely serve as examples and do not, in any way, limit the scope of the present invention.

For example, the force unit 15 may comprise at least one solenoid 155 fitted around at least a portion of the valve chamber 11 and/or the chamber body 131. That is, similar to the annular magnet 151, the valve chamber 11 may run through the central opening of the at least one solenoid 155. Preferably, the solenoid 155 may be tightly fitted to the valve chamber 11. That is, the space between the surface within the opening of the solenoid and the outer surface of the chamber body 11 may be minimized. Generally, a solenoid may denote a preferably cylindrical coil of wire, that may act as a magnet when a current is running through the wire.

It will be appreciated that for a solenoid 155, the direction of the magnetic field generally depends on the direction of a current running through wires of the solenoid 155. Thus, a solenoid may generate a magnetic field which may act in opposite directions based on the direction of the current in the solenoid 155. Thus, already a single solenoid 155 may be sufficient as a force unit 15. The solenoid may generally create a magnetic field which may be approximately uniform within the solenoid, i.e. within the opening comprising at least a portion of the valve chamber 11, and substantially perpendicular to the current, i.e. perpendicular to the preferably circularly shaped faces of the solenoid 155. Thus preferably, at least a portion of the magnetic field within the solenoid may be aligned with the central axis A1.

Thus, the magnetic field generated by the at least one solenoid 155 may exert a force on the magnetic portion 132 of the sealing body assembly 13, wherein the direction of the force may be controllable through the direction of the current applied to the solenoid 155. In some embodiments, the solenoid 155 may further be combined with a permanent magnet that may constantly provide a certain bias or preload on the sealing body assembly 13, for example for a magnetically preloaded pump inlet or outlet valve.

With reference to FIG. 5, the force unit 15 may for example comprise two solenoids 155A, 155B, wherein the valve chamber 11 may be located in the opening of each of the two solenoids 155A, 155B. That is, preferably, each of the two solenoids 155A, 155B may encompass a portion of the valve chamber 11. Thus, the sealing body assembly 13 may generally be moved through a magnetic force acting on the magnetic portion 132 which may be exerted by one or both of the solenoids 155A, 155B. For example, the first solenoid 155A may generate a magnetic field configured to attract the magnetic portion 132. In addition, the second solenoid 155B can generate a magnetic field configured to repel the magnetic portion 132, such that both solenoids 155A, 155B generate a field that is pushing (repelling) and/or pulling the sealing body assembly 13 towards the first solenoid 155A, e.g. in positive x-direction. Alternatively, it may be sufficient for only either the first solenoid 155A or the second solenoid 155B to generate the respective field. Thus, either by changing the direction of the current through both solenoids 155A, 155B or alternatively by switching between the two solenoids 155A, 155B each generating an attractive (or repulsive) magnetic field, the sealing body assembly 13 may be moved within the valve chamber 11 and thus the configuration the valve assembly 1 assumes may be actively controlled through the force unit 15, i.e. in this embodiment the solenoids 155A, 155B. In particular, the force unit 15 may control the configuration of the valve without the need of a mechanical link between the force unit 15 and the sealing body assembly 13. That is, the use of magnetic force may advantageously allow for exerting a force on the sealing body assembly 13 without need for physical contact, i.e. contactless. This may be particularly advantageous as no moving part is required between the inside and outside of the valve chamber, which would otherwise necessitate complex and difficult sealing.

It will be understood that it may also be feasible to place the valve chamber 11 between the two solenoids, e.g. in a Helmholtz coil.

With reference to FIG. 6 alternative embodiments of the sealing body assembly 13 are discussed. Generally, the sealing body assembly 13 may also be realized different to the embodiments discussed above. For example, the at least one sealing portion 131, 131A, 131B may be integrally formed with at least one further portion of the sealing body assembly 13, e.g. the remaining portion of the sealing body assembly 13. That is, instead of separate elements, e.g. balls, which are permanently fixed or mounted to the remaining portion of the sealing body assembly 13, the sealing body assembly 13 may be formed to comprise a sealing portion 131, 131A, 131B, which may be integral to the remaining portion of the sealing body assembly 13. Such a sealing portion 131 may for example take the form of a tip, such as a rounded tip, or a conical frustum. Again, it may be advantageous if the sealing portion 131, 131A, 131B comprises a different hardness to the sealing surface 14, 14A, 14B to allow for a calibration (e.g. forming/shaping) of the softer portion (i.e. sealing portion 131, 131A, 131B or sealing surface 14, 14A, 14B).

Additionally or alternatively, the sealing body assembly 13 may generally be formed of a magnetic material, that is, the sealing body assembly 13 may for example be formed of a ferromagnetic material. In other words, the magnetic portion 132 of the sealing body assembly 13 may correspond to the entire sealing body assembly 13.

Generally, the sealing body assembly 13 may comprise a corrosion-resistant coating. This may be advantageous if the sealing body assembly 13 is made of a material that is not corrosion-resistant, as the sealing body assembly 13 is subjected to any fluid passing through the valve chamber 11. Alternatively, at least an exterior portion of the sealing body assembly 13 may be corrosion-resistant. The exterior portion may be any portion of the sealing body assembly 13 that will get into contact with a fluid surrounding the sealing body assembly 13.

In other words, a 3/2-way valve (assembly) according to the present invention may for example be realized as depicted in FIG. 6, wherein the configuration of the valve assembly 13 may for example be switched via two fixed, alternately operated solenoids 155A, 155B. The valve assembly 1 may further comprise a translationally movable sealing body assembly 13, which may preferably be made of corrosion-resistant, ferromagnetic and/or magnetisable material, wherein the ends of the sealing body assembly 13 may be formed as sealing portions 131, e.g. sealing tips. In other embodiments, the sealing body assembly 13 may comprise a corrosion-resistant coating. Advantageously, the sealing portion 131 may be made of a slightly harder (or softer) material than that of the complementary sealing surface 14 (e.g. sealing seat), which may for example be a bore in a pressure-resistant tube. This may for example allow to calibrate (e.g. shape) the sealing interface by applying a hydraulic pressure, that presses the sealing portion 131 into the respective sealing surface 14. Alternatively, the calibration may also be achieved by applying a mechanical force instead of hydraulic pressure. In this case prior molding of the sealing surface 14 may also be used. The sealing interface, i.e. the projected area of the seal pairing (sealing portion 131, sealing surface 14) may be minimized. For example, the corresponding bore diameter could be approx. 0.4 mm and the movable cylindrical sealing body assembly 13 with one-sided sealing tip could have an outer diameter of approx. 2.5 mm. This may advantageously allow for reduced sealing forces applied to the movable sealing body assembly 13 and/or an improved leak tightness.

In general, it may be preferred, that the sealing portion 131 is made of a harder material compared to the sealing seat 14, since the sealing seat 14 may typically be fixedly mounted, i.e. it does not move during normal operation, and my slightly deform with every closing of the respective access.

Likewise, the material combination of the movable sealing body assembly 13 comprising, for example, a permanent magnetic core and a surrounding exterior portion with a one- or double-sided tip, may be slightly harder or softer than the corresponding sealing surface 14. The advantageous factor also being that a one-off hydraulic or mechanical calibration of the contact surface between the sealing surface 14 and the sealing portion 131 (i.e. the sealing interface) at the factory may be possible.

With reference to FIGS. 7A and 7B, a further exemplary embodiment of the valve assembly 1 is discussed. Generally, the sealing body assembly 13 may not entirely be located within the valve chamber 11. That is, a portion of the sealing body assembly 13 may be located outside of the valve chamber 11. In particular, the magnetic portion 132 of the sealing body assembly 13 may be located outside of the valve chamber 11, e.g. in a fluidly connected cavity 17.

That is, the valve chamber 11 may comprise the at least one sealing portion 131 of the sealing body assembly 13, while the magnetic portion 132 may be located in the cavity 17, which may preferably be aligned with the valve chamber 11. That is, preferably the central axis A1 may run centrally through both, the valve chamber 11 and the cavity 17 in x-direction. Moreover, the central axis may run centrally through the sealing portion 131 and the sealing surface 14.

Referring to FIG. 7A, the valve chamber 11 may comprise a chamber body 111 and a chamber seal 112 at one end of the valve chamber 11, wherein the chamber seal 112 may for example comprise the third access 123 to the valve chamber 11. At the opposite end of the valve chamber 11 the first access 121 may be provided. However, different to embodiments shown before, the sealing body assembly 13 may extend through the opening that provides the first access 121 to the valve chamber 11. The portion of the sealing body assembly 13 extending outside of the valve chamber 11 may preferably comprise the magnetic portion 132. Typically, there may be a trade-off between the magnetic field strength the force unit 15 may generate and the size of the magnetic portion 132 of the sealing body assembly 13 that is susceptible to the generated magnetic field. Thus, the magnetic portion 132 may not be arbitrarily small but instead limited to a minimal size required for sufficient force transmission, which may depend on the magnetic field generated by the force unit 15, but also on the geometry and material of the magnetic portion 132. Thus, locating the magnetic portion 132 of the sealing body assembly 13 outside the valve chamber volume may be advantageous for reducing said chamber volume and consequently the dead volume of the valve chamber 11.

The magnetic portion 132 of the sealing body assembly 13 may for example be located in a cavity 17 next to the valve chamber 11, which may comprise a larger volume than the valve chamber 11.

The second access 122 may be provided to the valve chamber 11 at a point in between the two ends comprising the first 121 and the third 123 access.

The at least one sealing portion may for example be shaped as a conical frustum 131A, 131B which may seal against correspondingly shaped sealing surfaces 14A, 14B. For example, the shape of the sealing surfaces 14A, 14B may be individually calibrated during the manufacturing process to substantially match the respective sealing portion 131A, 131B. Again, the calibration may for example be realized by applying a hydraulic or mechanical pressure that presses the sealing portion 131A, 131B into the respective sealing surface 14A, 14B, wherein there is a difference in the degree of hardness of the material between the sealing portion 131A, 131B and the respective sealing surface 14A, 14B, such that the softer portion is adapted to fit the harder portion in a sealing manner (i.e. sealingly).

Thus, in a first configuration I (depicted in FIG. 7A), the third access 123 may be fluidly connected to the second access 122 via the valve chamber 11, while the sealing portion 131A of the sealing body assembly 13 is pressed against the respective sealing surface 14A. Thus, the first access 121 may be sealed and there may be no fluidic connection between the valve chamber 11 and the cavity 17 comprising the magnetic portion 132 of the sealing body assembly 13.

In a second configuration II (not shown) the sealing body assembly 13 may be pushed towards the chamber seal 112, i.e. in the negative x-direction, such that the sealing portion 131B and the respective sealing surface 14B may form a leak-tight connection and thus block the fluidic connection between the third access 123 and the valve chamber 11. At the same time, the sealing portion 131A may be separated from the respective sealing surface 14A such that the first access 121 may be fluidic connected to the second access 122. Thus, the cavity 17 may be fluidic connected to the valve chamber 11.

In other words, such a design may provide a significantly reduced volume surrounding the translationally movable sealing body assembly 13 within the valve chamber 11. That is, the valve chamber volume that is not filled with a portion of the movable sealing body assembly 13 may be reduced compared to other embodiments. Thus, particularly when assuming configuration I the dead volume of the fluidic connection between the second access 122 and the third access 123 may be reduced compared to other designs. It may be realised by placing the preferably permanently magnetic and corrosion-resistant coated magnetic portion 132 in a further adjacent cavity 17. The depicted valve assembly 1 is designed as a 3/2-way valve. However, it will be understood, that the same principle may be applied to a 2/1-way valve.

With reference to FIG. 7B, the second 122 and third 123 access may be directly connected to a fitting 182, 183, which may also be referred to as a fluidic connector 182, 183, thus allowing to directly connect the second 122 and third 123 access to a respective capillary. The first access 121 may fluidic connect the valve chamber 11 to the cavity 17 comprising a portion of the sealing body assembly 13, preferably at least the magnetic portion 132 of the sealing body assembly 13. The cavity 17 may further be fluidly connected to a fitting 181 (which may also be referred to as a respective fluidic connector 181) such that the first access 121 may be fluidly connected to the respective fluidic connector 181 via the cavity 17.

The actuator 15 may comprise two permanent bar magnets 156A, 156B which may be magnetized along the x-direction, wherein the two bar magnets 156A, 156B are for example mounted to an actuator 152 such that the magnetization direction of the first bar magnet 156A is opposite to the magnetization of the second bar magnet 156B. That is, the two bar magnets 156A, 156B may each be magnetized along the direction of the central axis A1, however, in opposite directions. Further they may be mounted to an actuator 152 such that a single bar magnet 156A, 1566 may selectively be aligned with the magnetic portion 132 of the sealing body assembly 13. Thus, when for example the first bar magnet 156A is aligned with the magnetic portion 132 of the sealing body assembly 13 it may exert an attractive force on the magnetic portion 132 pulling the sealing body assembly 13 towards the bar magnet 156A (cf. FIG. 7A). Consequently, the valve assembly 1 may assume the first configuration I. In contrast, when the second bar magnet 156B is aligned with the magnetic portion 132 of the sealing body assembly 13 it may exert a repulsive force on the magnetic portion 132 pushing the sealing body assembly 13 away from the bar magnet 156B. Thus, the valve assembly 1 may assume the second configuration II. It will be understood that also the first magnet 156A may exert a repulsive force while the second magnet 156A exerts an attractive force. However, the two bar magnets 156A, 156B may always be aligned opposite to each other in terms of magnetization. Furthermore, it will be understood by the person skilled in the art, that a bar magnet may generally denote an elongated magnet with two poles at the respective ends. Particularly a bar magnet may not be limited to a rectangular-shaped bar magnet but may for example also denote a cylindrically-shaped bar magnet (also referred to as rod magnet) or other shapes such as a bar magnet with an elliptical cross section.

In other words, the force unit 15 may generally comprise two bar magnets 156A, 156B, which may be mounted to the actuator 152 next to each other in the direction of the linear or rotational displacement provided by the actuator 152. Furthermore, the respective magnetization direction of the two bar magnets may be oriented in opposite directions and perpendicular to the direction of the displacement provided by the actuator 152. The actuator 152 may be configured to linearly or rotationally displace the bar magnets 156A, 156B within a plane perpendicular to the central axis A1 and thereby selectively align one of the bar magnets 156A, 156B with the magnetic portion 132 of the sealing body assembly 13 in a plane perpendicular to the central axis.

Thus, by coupling the two bar magnets to an actuator 152, either directly or via a coupling unit 153, which may provide a linear or rotational motion, any one of the two bar magnets 156A, 156B may be aligned with the magnetic portion 132 and thus by changing the bar magnet that is aligned with the magnetic portion 132 of the sealing body assembly 13, the configuration assumed by the valve assembly 13 may be actively changed and/or supported. Therefore, the force unit 15 may allow to actively and deterministically switch the configuration assumed by the valve assembly 1, at least up to a maximal pressure difference specified by the differential pressure threshold.

It will be understood that generally any of the at least one sealing portion 131 may also assume another shape such as a tip, particularly sealing portion 131B in the depicted embodiment (FIG. 7A).

In other words, a 3/2-way valve assembly comprising for example a cylindrical magnetic portion 132 in a cavity 17 adjacent to the valve chamber 11 may be switched via a force unit 15 comprising a bar magnet 156A with magnetisation direction parallel to the central axis A1 and another axially oppositely polarised bar magnet 156B. Further, both bar magnets 156A, 156B may for example be displaceable in a common support (coupling unit 153) along an axis perpendicular to the opposing magnetization directions by an actuator 152 e.g. with a lifting magnet, so that either the bar magnet 156A or the bar magnet 156B aligns to an axis with the magnetic portion 132, e.g. the central axis A1 of the valve chamber 11.

Generally, a valve assembly according to the present invention may for example comprise a movable sealing body assembly 13 comprising a permanent magnetic core (i.e. a magnetic portion 132) and an exterior portion surrounding the magnetic core, which comprises a sealing portion 131, e.g. in form of a one-sided tip, which may at least be slightly softer, or alternatively harder, than the complementary sealing surface 14, e.g. sealing seat 14. That is, the sealing portion 131 and the sealing surface 14 may differ as regards their respective hardness. Furthermore, the sealing interface, i.e. the contact area of the sealing portion 131 and the sealing surface 14, may be calibrated (e.g. formed/shaped) during production by pressing the sealing geometry into the respective sealing portion 131 and/or sealing surface 14 or by pressing the sealing portion 131 into the sealing surface 14 when the valve assembly is in an assembled state, e.g. by applying a hydraulic pressure. The exterior portion may generally provide protection of the magnetic portion 132 against chemical and/or mechanical stress.

Further, an opening or closing force may be actively applied via a force unit 15 to the centrally positioned and translationally movable sealing body assembly 13 comprising the magnetic portion 132. The force unit 15 may comprise at least one outer permanent annular magnet 151 or at least one magnetic coil 155 with a homogeneous magnetic field in the centre or a plurality of permanent-magnetic bar magnets 156A, 1566, can be axially pivoted and/or displaced in alternating orientation of the poles by means of the actuator 152. The valve assembly 1 may thus advantageously provide means to actively switch the flow direction at a pressure significantly lower than system pressure and at the same time a passive seal, e.g. on at least one side, as a check valve at system pressure. Further, it may enable for active interruption and release of flow at differential pressures typically up to a differential pressure threshold of for example approximately 50 bar, while generally at applied system pressure.

Overall, a valve assembly 1 according to the present invention may allow for a higher reliability for particle-contaminated fluids and a more uniform tightness across the pressure range. In particular, the configuration of the valve assembly 1 may also be deterministically switched (e.g. it may be opened or closed) at low differential pressures and independent of the spatial orientation of the valve (i.e. independent of gravity). Similarly, it may overcome the problem of faulty closing behaviour for poorly degassed fluids, due to air bubbles which may be trapped within the check valve.

Further, it provides faster switching times than passive check valves and active control of the flow direction for limited differential pressures, i.e. up to the differential pressure threshold, even at high system pressures.

Furthermore, a valve assembly 1 according to the present invention may be utilized within a pump system comprising at least one pump unit, for example as an inlet valve and/or outlet valve to the at least one pump unit. This may be particularly interesting if the pump unit is a positive displacement pump unit, for example a piston pump unit. The pump system may also comprise a plurality of pump units which may be operated in parallel, series or any combination thereof. That is, it may also be used in a system comprising four pump units, with two parallel flow paths, whereof each comprises two pump units in series. Utilizing a valve assembly according to the present invention in a pump system may be advantageous, as it may provide a reduced complexity and/or increased robustness in comparison to known (active) check valves. Thus, the pump system would be rendered less complex and/or more robust, which may for example be advantageous for manufacturing, installation, use and maintenance of the pump system. Further, such a pump system may provide the possibility of reversing the flow, particularly if all check valves of the pump system are valve assemblies according of the present invention. This may advantageously provide improved flushing behaviour for piston pumps, i.e. it may enable effective purging of piston pumps. Yet further, such a pump system may allow for improved diagnostic procedures, e.g. for controlling the flow of the at least one pump and/or for avoiding pressure drops when alternately conveying a fluid with two pump pistons.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, a preferred embodiment has been described with reference to the accompanying drawings, the skilled person will understand that this embodiment was provided for illustrative purpose only and should by no means be construed to limit the scope of the present invention, which is defined by the claims.

What is claimed is:

1. A valve assembly, comprising
a valve chamber;
accesses to the valve chamber, the accesses including a first access and a second access;
a movable sealing body assembly comprising at least one sealing portion,
wherein at least a portion of the sealing body assembly is magnetic, and
wherein at least a portion of the sealing body assembly comprising the at least one sealing portion is located within the valve chamber;
at least one sealing surface,
wherein each of the at least one sealing surface is configured to complement one of the at least one sealing portion, and
wherein each sealing surface comprises an orifice fluidly connected to one of the accesses; and
a force unit configured to exert a magnetic force on the magnetic portion of the movable sealing body assembly,
wherein the valve assembly is configured to assume at least two configurations,
wherein in a first configuration, the first access is sealed, and
wherein in a second configuration, the first access is fluidly connected to the second access.

2. The valve assembly according to claim 1, wherein the sealing surface and the sealing portion configured to complement said sealing surface are configured to form a leak-tight sealing interface when pressed together, which seals the orifice comprised by the sealing surface.

3. The valve assembly according to claim 1, wherein a hardness of the at least one sealing portion is different to a hardness of the at least one sealing surface.

4. The valve assembly according to claim 1, wherein the force unit is configured to press the sealing portion against the complementary sealing surface by exerting the force on the magnetic portion.

5. The valve assembly according to claim 1, wherein the force unit is configured to move the sealing body assembly and/or to actively change the configuration assumed by the valve assembly by exerting the force on the magnetic portion at least for any differential pressure between any of the accesses to the valve chamber that does not exceed a differential pressure threshold, wherein the differential pressure threshold is at least 20 bar, preferably at least 50 bar, more preferably at least 100 bar.

6. The valve assembly according to claim 1, wherein the force unit comprises at least one a permanent magnet and an actuator configured to provide a rotational or linear motion,
wherein the actuator is configured to provide a linear or rotational displacement to the at least one permanent magnet connected thereto.

7. The valve assembly according to claim 1, wherein the force unit comprises at least one solenoid.

8. The valve assembly according to claim 1, wherein the movable sealing body assembly is not firmly attached to any other portion of the valve assembly.

9. A pump system configured to provide a flow of fluid, wherein the system comprises
at least one pump unit;
an inlet valve configured to control a fluid flow at an inlet of at least one of the at least one pump unit; and
an outlet valve configured to control a fluid flow at an outlet of at least one of the at least one pump unit,
wherein at least one of the inlet valve and the outlet valve is a valve assembly according to claim 1.

10. The pump system according claim 9, wherein the pump system is configured for reversing the flow through the pump system to purge the system.

11. Manufacturing method for manufacturing a valve assembly according to claim 1, wherein the manufacturing comprises calibrating the at least one sealing portion and/or the complementary sealing surface to provide an accurately fitting sealing contour.

12. Manufacturing method according to claim 11, wherein the at least one sealing portion and the complementary sealing surface comprise different degrees of hardness, and wherein the step of calibrating comprises applying a hydraulic pressure configured to press the sealing portion and the sealing surface together while the valve assembly is assembled.
